(19) United States
(12) Patent Application Publication
(10) Pub. No.: US 2026/0319742 A1
(43) Pub. Date: Oct. 15, 2026

(54) CALCULATION PROCESSING SYSTEM

(71) Applicant: QUALCOMM Incorporated, San Diego, CA (US)

(72) Inventors: Andrew Evan GRUBER, Arlington, MA (US); Ewen Murray VOWELS, North Melbourne (AU); Chiente HO, San Jose, CA (US)

(21) Appl. No.: 19/178,686

(22) Filed: Apr. 14, 2025

(51) Int. Cl. G06F 7/544; G06F 7/44

(52) U.S. Cl. CPC G06F 7/5443; G06F 7/44

(57) ABSTRACT

This disclosure provides systems, devices, apparatus, and methods, including computer programs encoded on storage media, for performing a calculation. A processor may obtain a first indication of a first command to multiply a first plurality of numbers. The processor may determine, via a first set of hardware multipliers, via a proper subset of a second set of hardware multipliers, and via a set of hardware adders, a first product of the first plurality of numbers in response to the obtained first indication of the first command. Each hardware multiplier of the first set of hardware multipliers may have a first multiplier path having a first bit-size. Each hardware multiplier of the second set of hardware multipliers may have a second multiplier path having a second bit-size. The first bit-size and the second bit-size may not be equal. The processor may output the determined first product.

### TECHNICAL FIELD

The present disclosure relates generally to processing systems, and more particularly, to one or more techniques for processing a mathematical calculation.

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques may not address inefficiencies in using hardware multipliers configured to multiply numbers having a bit-size to perform multiplication on numbers having a larger bit-size. There is a need for improved calculation techniques.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a memory; and at least one processor coupled to the memory and, based at least in part on information stored in the memory, the at least one processor may be configured to obtain a first indication of a first command to multiply a first plurality of numbers. The at least one processor may be configured to obtain a second indication of a second command to add a plurality of products of a second plurality of numbers. The at least one processor may be configured to determine, via a first set of hardware multipliers, via a proper subset of a second set of hardware multipliers, and via a set of hardware adders, a first product of the first plurality of numbers in response to the obtained first indication of the first command. The at least one processor may be configured to determine, via the second set of hardware multipliers, the plurality of products of the second plurality of numbers in response to the obtained second indication of the second command. Each hardware multiplier of the first set of hardware multipliers may have a first multiplier path having a first bit-size. Each hardware multiplier of the second set of hardware multipliers may have a second multiplier path having a second bit-size. The first bit-size and the second bit-size may not be equal. The at least one processor may be configured to output the determined first product. The at least one processor may be configured to output a sum of the determined plurality of products.

In some aspects, the techniques described herein relate to a method of calculation, including: obtaining a first indication of a first command to multiply a first plurality of numbers or a second indication of a second command to add a plurality of products of a second plurality of numbers; determining, via a first set of hardware multipliers, via a proper subset of a second set of hardware multipliers, and via a set of hardware adders, a first product of the first plurality of numbers in response to the obtained first indication of the first command; or determining, via the second set of hardware multipliers, the plurality of products of the second plurality of numbers in response to the obtained second indication of the second command, where each hardware multiplier of the first set of hardware multipliers has a first multiplier path having a first bit-size, where each hardware multiplier of the second set of hardware multipliers has a second multiplier path having a second bit-size, where the first bit-size and the second bit-size are not equal; and outputting the determined first product or a sum of the determined plurality of products.

In some aspects, the techniques described herein relate to a method, where the first bit-size is greater than the second bit-size.

In some aspects, the techniques described herein relate to a method, where the first bit-size includes 24-bits and the second bit-size includes 8-bits.

In some aspects, the techniques described herein relate to a method, where the first set of hardware multipliers includes a single 24-bit by 24-bit hardware multiplier, where the second set of hardware multipliers includes four 8-bit by 8-bit hardware multipliers, where the first command includes a command to multiply two 32-bit numbers, and wherein the second command includes a command to perform a four wide vector dot product (DP4) of eight 8-bit numbers.

In some aspects, the techniques described herein relate to a method, further including: obtaining a third indication of a third command to multiply a third plurality of numbers; determining, via the first set of hardware multipliers and not the second set of hardware multipliers, a third product of the third plurality of numbers in response to the obtained third indication of the third command; and outputting the determined third product.

In some aspects, the techniques described herein relate to a method, where the first plurality of numbers include 32-bit numbers, where the third plurality of numbers include 24-bit numbers.

In some aspects, the techniques described herein relate to a method, where the first plurality of numbers includes a first number and a second number, where the first number includes a first portion, a second portion, and a third portion, and the second number includes a fourth portion, a fifth portion, and a sixth portion, where determining, via the first set of hardware multipliers and the proper subset of the second set of hardware multipliers, the first product of the first plurality of numbers in response to the obtained first indication of the first command includes: determining, via the first set of hardware multipliers, a third product of the first portion and the fourth portion; determining, via a first hardware multiplier of the second set of hardware multipliers, a fourth product of the second portion and the sixth portion; determining, via a second hardware multiplier of the second set of hardware multipliers, a fifth product of the third portion and the fifth portion; and determining, via the set of hardware adders, a second sum of the determined third product, the determined fourth product, and the determined fifth product.

In some aspects, the techniques described herein relate to a method, where determining, via the set of hardware adders, the second sum of the determined third product, the determined fourth product, and the determined fifth product, includes: selecting, via a first hardware multiplexor, a first output of the first set of hardware multipliers; determining, via a first hardware adder of the set of hardware adders, a third sum of the determined fourth product and the determined fifth product; and determining, via a second hardware adder of the set of hardware adders, a fourth sum of the third sum and the selected first output of the first set of hardware multipliers, where the determined first product includes the determined fourth sum.

In some aspects, the techniques described herein relate to a method, where the first hardware adder includes a 16-bit hardware adder, and wherein the second hardware adder includes a 32-bit hardware adder.

In some aspects, the techniques described herein relate to a method, where determining, via the set of hardware adders, the second sum of the determined third product, the determined fourth product, and the determined fifth product, includes: selecting, via a second hardware multiplexor, a second output of the first hardware adder, wherein a third output of the second hardware multiplexor is connected to an input of the second hardware adder associated with the second sum

In some aspects, the techniques described herein relate to a method, where determining, via the set of hardware adders, the second sum of the determined third product, the determined fourth product, and the determined fifth product, includes: determining, via a hardware adder of the set of hardware adders, the second sum of the determined third product, the determined fourth product, and the determined fifth product, where the determined first product includes the determined second sum.

In some aspects, the techniques described herein relate to a method, where the hardware adder includes a 32-bit hardware adder.

In some aspects, the techniques described herein relate to a method, further including: obtaining a third indication of a third command to add a fourth number to a product of a fifth number and a sixth number, where the fifth number includes a seventh portion, an eighth portion, and a ninth portion, where the sixth number includes a tenth portion, an eleventh portion, and a twelfth portion; determining, via the first set of hardware multipliers, a sixth product of the seventh portion and the tenth portion; determining, via the first hardware multiplier of the second set of hardware multipliers, a seventh product of the eighth portion and the twelfth portion; determining, via the second hardware multiplier of the second set of hardware multipliers, an eighth product of the ninth portion and the eleventh portion; determining, via the hardware adder of the set of hardware adders, a third sum of the determined sixth product, the determined seventh product, and the determined eighth product; determining, via a second hardware adder of the set of hardware adders, a fourth sum of the determined third sum and the fourth number; and outputting the determined fourth sum.

In some aspects, the techniques described herein relate to a method, where the second plurality of numbers includes a first number, a second number, a third number, a fourth number, a fifth number, a sixth number, a seventh number, and an eighth number, where determining, via the second set of hardware multipliers, the plurality of products of the second plurality of numbers in response to the obtained second indication of the second command includes: determining, via a first hardware multiplier of the second set of hardware multipliers, a third product of the first number and the fifth number; determining, via a second hardware multiplier of the second set of hardware multipliers, a fourth product of the second number and the sixth number; determining, via a third hardware multiplier of the second set of hardware multipliers, a fifth product of the third number and the seventh number; determining, via a fourth hardware multiplier of the second set of hardware multipliers, a sixth product of the fourth number and the eighth number; and determining, via a hardware adder, a second sum of the determined third product, the determined fourth product, the determined fifth product, and the determined sixth product, where the determined second sum includes the sum of the determined plurality of products.

In some aspects, the techniques described herein relate to a method, where each of the first hardware multiplier, the second hardware multiplier, the third hardware multiplier, and the fourth hardware multiplier includes an 8-bit by 8-bit hardware multiplier.

In some aspects, the techniques described herein relate to a method, where outputting the determined first product or the sum of the determined plurality of products includes: outputting an indication of the determined first product or the sum of the determined plurality of products; or storing an indication of the determined first product or the sum of the determined plurality of products.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example computer system in accordance with one or more techniques of this disclosure.

FIG. 2 is a block diagram of a set of hardware devices configured to perform different types of calculations on a set of numbers, in accordance with one or more techniques of this disclosure.

FIG. 3 is a block diagram of a set of hardware devices configured to perform different types of calculations on a set of numbers, in accordance with one or more techniques of this disclosure.

FIG. 4 is a block diagram of a set of hardware devices configured to perform different types of calculations on a set of numbers, in accordance with one or more techniques of this disclosure.

FIG. 5 is a block diagram of a set of hardware devices configured to perform different types of calculations on a set of numbers, in accordance with one or more techniques of this disclosure.

FIG. 6 is a block diagram of a set of hardware devices configured to perform different types of calculations on a set of numbers, in accordance with one or more techniques of this disclosure.

FIG. 7 is a call flow diagram illustrating example communications between a command processor (CP) and a hardware calculator, in accordance with one or more techniques of this disclosure.

FIG. 8 is a flowchart of an example method of processing a calculation in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

The following description is directed to examples for the purposes of describing innovative aspects of this disclosure. However, a person having ordinary skill in the art may recognize that the teachings herein may be applied in a multitude of ways. Some or all of the described examples may be implemented in any device or system that is capable of processing graphics commands. Various aspects relate generally to performing calculations (e.g., multiplication, addition) on a processor, such as a central processing unit (CPU) or a graphics processing unit (GPU). Some aspects more specifically relate to performing a 4-wide vector dot product operation (DP4) on four numbers, performing a multiplication operation (MUL) of two numbers, or performing a multiply add (MUL ADD) on three numbers. For example, a graphics system may have a multitude of hardware devices specifically configured to rapidly perform such calculations concurrently, or in parallel.

In some aspects, a processor (e.g., CPU, GPU, graphics processor, graphics processor system) may have a hardware device configured to perform a set of operations on a set of input variables. A hardware device may be a dedicated hardware block configured to (1) accept a set of input variables (e.g., numbers), (2) perform a set of operations on the set of input variables, and (3) output a result of the set of operations on the set of input variables. An operation may include a multiplication operation (MUL), which multiplies a plurality of numbers to compute a product. An operation may include an addition operation (ADD), which adds a plurality of numbers to compute a sum. An operation may include a multiplexor operation (MUX), which selects a number from a plurality of input numbers for output. The set of hardware devices may be chained to perform an operation on a set of input numbers, or variables. For example, the set of hardware devices may be chained to perform a MUL on a plurality of numbers to compute a product. In another example, the set of hardware devices may be chained to perform a multiply add operation, also referred to a multiply accumulate (MUL_ACC) operation, which multiplies a plurality of numbers and adds a second set of numbers to the product of the plurality of numbers. In another example, the set of hardware devices may be chained to perform an N-wide vector dot product (DPN) on a plurality of numbers to multiply pairs of numbers and add the resulting products. A specific example may be a four wide vector dot product (DP4) of eight 8-bit numbers, which may be a sum of each of the products of four pairs of 8-bit numbers. In another example, the set of hardware devices may be chained to perform a DPN accumulate (DPN_ACC) operation, such as a DP4 accumulate (DP4_ACC) operation, which then adds an additional number to the sum of each of the products of the pairs of numbers. A hardware device may have an operation path having a given bit-size, which limits the bit-size of the inputs to the hardware device. In some aspects, a hardware multiplier may have a multiplier path that multiplies numbers of a given input bit-size to generate a product. The product may be any number of bits large, for example the output may be the same size as the input bit-size, may be twice as large as the input bit-size (e.g., when multiplying two numbers), or may be four times as large as the input bit-size (e.g., when multiplying four numbers). In some aspects, a hardware adder may have an addition path that adds numbers of a given input bit-size to generate a sum. The sum may be any number of bits large, for example the output may be the same size as the input bit size, may be one bit larger than the input bit size (e.g., when adding two numbers), or may be any number of bits larger than the input bit size. In some aspects, a hardware multiplexor may have a multiplex path that selects a number from a plurality of input numbers of a given input bit-size to generate an output of that same given input bit-size. In other words, a hardware device having an operation path of a given bit-size may be configured to accept input values of the given bit-size, but may output a value having the same given bit-size, or a different bit-size than the given bit-size.

As an example, a 24x24 MUL may be a hardware multiplier with a multiplier path having a 24-bit bit-size, which accepts two inputs having a 24-bit bit-size each, and which produces an output product. In some aspects, the output product of the 24x24 MUL may be a 48-bit bit-size. In other aspects, the least significant bits (LSBs) of the output product may be output if the output product exceeds an output bit-size. For example, where the output product is output to a 32-bit general purpose register (GPR), the output product of the 24x24 MUL may be a 32-bit bit-size, where the output product is the 32 LSBs of the product of the two 24-bit inputs. In another example, an 8x8 MUL may be a hardware multiplier with a multiplier path having an 8-bit bit-size, which accepts two inputs having an 8-bit bit-size each, which produces an output product. The output product may have a 16-bit bit-size. In another example, a 32x32 MUL may be a hardware multiplier with a multiplier path having a 32-bit bit-size, which accepts two inputs having a 32-bit bit-size each, which produces an output product. The output product may have a 64-bit bit-size, whereas in other aspects the output product of the 32x32 MUL may have a 32-bit bit-size. For example, the 32x32 MUL may output the 32 LSBs of the output product to a 32-bit GPR. In another example, a 16+16+16+16 ADD may be a hardware adder with an addition path having a 16-bit bit-size, which accepts four inputs having a 16-bit bit-size each, and which produces an output sum having an 18-bit bit-size. In some aspects, the output sum may be configured to have a bit-size that is larger than 18 bits, for example a 24-bit bit-size or a 32-bit bit-size. In such aspects, the MSBs of the output sum may be padded with zeros. In another example, a 32+32+32+32 ADD may be a hardware adder with an addition path having a 32-bit bit-size, which accepts four inputs having a 32-bit bit-size each, and which produces an output sum having a 34-bit bit-size. In some aspects, the output sum may be configured to have a bit-size that is smaller than 32 bits, for example a 32-bit bit-size. In such aspects, the MSBs of the output sum (i.e., [33:32]) may be truncated. In another example, a 32+32 ADD may be a hardware adder with an addition path having a 32-bit bit-size, which accepts two inputs having a 32-bit bit-size each, and which produces an output sum having a 34-bit bit-size. In some aspects, the output sum may be configured to have a 32-bit bit-size. In another example, a 32 MUX may be a hardware multiplexor with a multiplex path that selects a 32-bit output number from two 32-bit input numbers. In another example, an 8 MUX may be a hardware multiplexor with a multiplex path that selects an 8-bit output number from two 8-bit input numbers.

In some aspects, a processor (e.g., CPU, GPU, graphics processor, graphics processor system) may leverage a set of four 8-bit hardware multipliers and a single 24-bit hardware multiplier to create a single-cycle 32x32 multiply operation. A single-cycle operation is an operation that does not cycle through the same hardware device twice in order to calculate a result of the operation. The processor may use a set of eight 8-bit hardware multiplexors (i.e., multiplexors having an 8-bit bit-size) to select inputs to the four 8-bit hardware multipliers (i.e., multipliers having an 8-bit bit-size). Selecting inputs to the four 8-bit hardware multipliers using hardware multiplexors may be computationally cheaper than expanding the logic of the single 24-bit hardware multiplier (e.g., by cycling through the hardware multiplier a plurality of times), and may be computationally cheaper than adding an additional 32-bit hardware multiplier.

In some examples, a processor (e.g., CPU, GPU, graphics processor, graphics processor system) may be configured to perform a plurality of operations, for example at least two operations of a multiplication operation, a multiply add operation, a four-wide vector dot product (DP4), and a DP4 add operation. The processor may be configured to select an operation from the plurality of operations via an input indicator, or selector, variable. The processor may be implemented in a wireless communication device. The processor may be configured to obtain a first indication of a first command to multiply a first plurality of numbers. For example, the first indication may include a command to a plurality of hardware multiplexors to select outputs that are associated with multiplying two 32-bit numbers. The processor may be configured to determine, (a) via a first set of hardware multipliers, (b) via a proper subset of a second set of hardware multipliers, and (c) via a set of hardware adders, a first product of the first plurality of numbers in response to the obtained first indication of the first command. For example, the processor may be configured to compute a first product via the first set of hardware multipliers, a second product via the proper subset of the second set of hardware multipliers, and may then add the first product and the second product via the set of hardware adders to multiply the first plurality of numbers. A proper subset of a set of hardware devices includes at least one hardware device of the set of hardware devices, but does not include all of the hardware devices of the set of hardware devices. Each hardware multiplier of the first set of hardware multipliers may have a first multiplier path having a first bit-size. Each hardware multiplier of the second set of hardware multipliers may have a second multiplier path having a second bit-size. The first bit-size and the second bit-size may not be equal. The first bit-size may be greater than the second bit-size. For example, the first bit-size may be a 24-bit bit-size (i.e., accepts inputs of 24-bits), and the second bit-size may be an 8-bit bit-size (i.e., accepts inputs of 8-bits). The first set of hardware multipliers may include a single 24-bit by 24-bit hardware multiplier. The second set of hardware multipliers may include four 8-bit by 8-bit hardware multipliers. The first command may include a command to multiply two 32-bit numbers. The first plurality of numbers may include a first number and a second number. The first number and the second number may include the two 32-bit numbers. In other words, the first command may be a command to multiply the first number, a first 32-bit number, and the second number, a second 32-bit number, where the processor computes the product of the first 32-bit number and the second 32-bit number by using a single 24-bit by 24-bit hardware multiplier and a proper subset of a set of four 8-bit by 8-bit hardware multipliers. The first number may include a first portion, a second portion, and a third portion. For example, the first number may be referred to as SRC0, and may have 32 bits referred to as SRC0[31:0]. The first portion may be SRC0[23:0], the second portion may be SRC0[7:0], and the third portion may be [31:24]. The second number may include a fourth portion, a fifth portion, and a sixth portion. For example, the second number may be referred to as SRC1, and may have 32 bits referred to as SRC1[31:0]. The fourth portion may be SRC1[23:0], the fifth portion may be SRC1[7:0], and the sixth portion may be SRC1[31:24]. To determine, via the first set of hardware multipliers and the proper subset of the second set of hardware multipliers, the first product of the first plurality of numbers in response to the obtained first indication of the first command, the processor may be configured to (1) determine, via the first set of hardware multipliers, a third product of the first portion and the fourth portion, (2) determine, via a first hardware multiplier of the second set of hardware multipliers, a fourth product of the second portion and the sixth portion, (3) determine, via a second hardware multiplier of the second set of hardware multipliers, a fifth product of the third portion and the fifth portion, and (4) determine, via the set of hardware adders, a second sum of the determined third product, the determined fourth product, and the determined fifth product. In one aspect, the third product may be a product of SRC0[23:0] and SRC1[23:0] multiplied using a 24-bit by 24-bit hardware multiplier. In one aspect, the fourth product may be a product of SRC0[7:0] and SRC1[31:24] using an 8-bit by 8-bit hardware multiplier. In one aspect, the fifth product may be a product of SRC0[31:24] and SRC1[7:0] using an 8-bit by 8-bit hardware multiplier. The set of hardware adders may be used to add the third product, the fourth product, and the fifth product with one another. The sum of the third product, the fourth product, and the fifth product may be equivalent to the product of the first number and the second number. To determine, via the set of hardware adders, the second sum of the determined third product, the determined fourth product, and the determined fifth product, the processor may be configured to (1) select, via a first hardware multiplexor, a first output of the first set of hardware multipliers, (2) determine, via a first hardware adder of the set of hardware adders, a third sum of the determined fourth product and the determined fifth product, and (3) determine, via a second hardware adder of the set of hardware adders, a fourth sum of the third sum and the selected first output of the first set of hardware multipliers. For example, the first hardware multiplexor may be a multiplexor with two inputs: a first input from the first set of hardware multipliers (e.g., a product of SRC0[23:0] and SRC1[23:0] multiplied using a 24-bit by 24-bit hardware multiplier), and a second input from a set of adders, and the first hardware multiplexor may select the first input from the first set of hardware multipliers based on the first indication of the first command to multiply the first plurality of numbers. The first hardware adder of the set of hardware adders may be used to determine a sum of the determined fourth product (e.g., a product of SRC0[7:0] and SRC1[31:24] using an 8-bit by 8-bit hardware multiplier), and the determined fifth product (e.g., a product of SRC0[31:24] and SRC1[7:0] using an 8-bit by 8-bit hardware multiplier). The second hardware adder may be used to determine a sum of the aforementioned sum of the determined fourth product and the determined fifth product and the aforementioned selection of the product from the first set of hardware multipliers. The determined first product may include the determined second sum. The final sum may be the product of the first number and the second number. The first hardware adder may include a 16-bit hardware adder. In other words, the first hardware adder may sum 16-bit numbers. The second hardware adder may include a 32-bit hardware adder. In other words, the second hardware adder may sum 32-bit numbers. To determine, via the set of hardware adders, the second sum of the determined third product, the determined fourth product, and the determined fifth product, the processor may be configured to select, via a second hardware multiplexor, a second output of the first hardware adder. In other words, the second hardware multiplexor may have two inputs, a first input which is from the first hardware adder, and a second input which is from another multiplexor. The second hardware multiplexor may select the first input based on the indication of the first command to multiply the first plurality of numbers. A third output of the second hardware multiplexor may be connected to an input of the second hardware adder associated with the second sum. In other words, the second hardware adder may add the out from the first set of hardware multipliers with the selected first input from the second hardware multiplexor. This sum may be equivalent to the product of the first number and the second number. To determine, via the set of hardware adders, the second sum of the determined third product, the determined fourth product, and the determined fifth product, the processor may be configured to determine, via a hardware adder of the set of hardware adders, the second of the determined third product, the determined fourth product, and the determined fifth product. In other words, a single hardware adder may be used to add the determined third product, the determined fourth product, and the determined fifth product. The single hardware adder may be a 32-bit hardware adder. The output of the single hardware adder may be equivalent to the product of the first number and the second number. In other words, the determined first product may be calculated as the determined second sum. The processor may be configured to output the determined first product of the first number and the second number. To output the determined first product, the processor may be configured to save the determined first product to a memory. To output the determined first product, the processor may be configured to transmit the determined first product to another component of the processor, for example an input to a graphics pipeline. To output the determined first product, the processor may be configured to output an indication of the determined first product, for example to another component of the processor. To output the determined first product, the processor may be configured to store an indication of the determined first product on a memory of the processor (e.g., graphics memory (GMEM)), or to an external memory (e.g., system memory). The processor may obtain a third indication of a third command to add a fourth number to a product of a fifth number and a sixth number. In other words, the indication may indicate a multiply add operation. The first indication may include the third indication. The fifth number may include a seventh portion, an eighth portion, and a ninth portion. For example, the fifth number may be a 32-bit number designated as SRC0[31:0], where the seventh portion may be bits [23:0] of SRC0, the eighth portion may be bits [7:0] of SRC0, and the ninth portion may be bits [31:24] of SRC0. The sixth number may include a tenth portion, an eleventh portion, and a twelfth portion. For example, the sixth number may be a 32-bit number designated as SRC1[31:0], where the tenth portion may be bits [23:0] of SRC1, the eleventh portion may be bits [7:0] of SRC1, and the twelfth portion may be bits [31:24] of SRC1. The processor may determine, via the first set of hardware multipliers, a sixth product of the seventh portion and the tenth portion. For example, the sixth product may be the product of SRC0[23:0] and SRC1[23:0]. The processor may determine, via the first hardware multiplier of the second set of hardware multipliers, a seventh product of the eighth portion and the twelfth portion. For example, the seventh product may be the product of SRC0[7:0] and SRC1[31:24]. The processor may determine, via the second hardware multiplier of the second set of hardware multipliers, an eighth product of the ninth portion and the eleventh portion. For example, the eighth product may be the product of SRC0[31:24] and SRC1[7:0]. The processor may determine, via the hardware adder of the set of hardware adders, a third sum of the determined sixth product, the determined seventh product, and the determined eighth product. For example, the hardware adder may calculate the third sum by adding the determined sixth product, the determined seventh product, and the determined eighth product. The processor may determine, via a second hardware adder of the set of hardware adders, a fourth sum of the determined third sum and the fourth number. The processor may output the determined second sum. For example, the hardware adder may calculate the fourth sum by adding the third sum with the fourth number.

In some examples, the processor (e.g., CPU, GPU, graphics processor, graphics processor system) may be configured to obtain a second indication of a second command to add a plurality of products of a second plurality of numbers. For example, the first indication may include a command to a plurality of hardware multiplexors to select outputs that are associated with performing a four-wide vector dot product (DP4), also referred to as a sum of four products, where each product is calculated by multiplying two numbers. The processor may be configured to determine, via the second set of hardware multipliers, the plurality of products of the second plurality of numbers in response to the obtained second indication of the second command. For example, the processor may be configured to determine a first product of the plurality of products via a first hardware multiplier of the second set of hardware multipliers, a second product of the plurality of products via a second hardware multiplier of the second set of hardware multipliers, and so on and so forth. Each hardware multiplier of the first set of hardware multipliers may have a first multiplier path having a first bit-size and each hardware multiplier of the second set of hardware multipliers may have a second multiplier path having a second bit-size, where the second bit-size is not equal to the first bit-size. The first bit-size may be greater than the second bit-size. For example, the first bit-size may be a 24-bit bit-size (i.e., accepts inputs of 24-bits), and the second bit-size may be an 8-bit bit-size (i.e., accepts inputs of 8-bits). The second plurality of numbers may include a first number, a second number, a third number, a fourth number, a fifth number, a sixth number, a seventh number, and an eighth number. The first number, second number, third number, and fourth number may be referred to as a single source number that is a concatenation of each of the first number, the second number, the third number, and the fourth number. For example, the first number may be referred to as bits [31:24] of the single source number, or SRC0[31:24], the second number may be referred to as bits [23:16] of the single source number, or SRC0[23:16], the third number may be referred to as bits [15:8] of the single source number, or SRC0[15:8], and the fourth number may be referred to as bits [7:0] of the single source number, or SRC0[7:0]. Similarly, the fifth number, sixth number, seventh number, and eighth number may be referred to as a second single source number that is a concatenation of each of the fifth number, the sixth number, the seventh number, and the eighth number. For example, the fifth number may be referred to as bits [31:24] of the second single source number, or SRC1[31:24], the sixth number may be referred to as bits [23:16] of the second single source number, or SRC1[23:16], the seventh number may be referred to as bits [15:8] of the second single source number, or SRC1[15:8], and the eighth number may be referred to as bits [7:0] of the second single source number, or SRC1[7:0]. To determine, via the second set of hardware multipliers, the plurality of products of the second plurality of numbers in response to the obtained second indication of the second command, the processor may be configured to (a) determine, via a first hardware multiplier of the second set of hardware multipliers, a third product of the first number and the fifth number, (b) determine, via a second hardware multiplier of the second set of hardware multipliers, a fourth product of the second number and the sixth number, (c) determine, via a third hardware multiplier of the second set of hardware multipliers, a fifth product of the third number and the seventh number, (d) determine, via a fourth hardware multiplier of the second set of hardware multipliers, a sixth product of the fourth number and the eighth number, and (e) determine, via a hardware adder, a second sum of the determined third product, the determined fourth product, the determined fifth product, and the determined sixth product. In other words, the processor may use the first hardware multiplier to determine a product of SRC0[31:24] and SRC1[31:24] (i.e., the third product), the second hardware multiplier to determine a product of SRC0[23:16] and SRC1[23:16] (i.e., the fourth product), the third hardware multiplier to determine a product of SRC0[15:8] and SRC1[15:8] (i.e., the fifth product), and the sixth hardware multiplier to determine a product of SRC0[7:0] and SRC1[7:0] (i.e., the fourth product). The processor may then use the hardware adder to add the determined third product, the determined fourth product, the determined fifth product, and the determined sixth product to calculate the second sum. The determined second sum may include the sum of the determined plurality of products. In other words, the hardware adder may determine the sum of the determined plurality of products. Each of the first hardware multiplier, the second hardware multiplier, the third hardware multiplier, and the fourth hardware multiplier may include an 8-bit by 8-bit hardware multiplier. In other words, the inputs to each of the first hardware multiplier, the second hardware multiplier, the third hardware multiplier, and the fourth hardware multiplier may be two 8-bit numbers. To output the sum of the determined plurality of products, the processor may be configured to output an indication of the sum of the determined plurality of products, for example to a component of the processor. To output the sum of the determined plurality of products, the processor may be configured to store an indication of the sum of the determined plurality of products, for example to a memory of the processor or to an external memory.

The processor may be configured to obtain a third indication of a third command to multiply a third plurality of numbers. The third plurality of numbers may be different than the first plurality of numbers. For example, the first plurality of numbers may include 32-bit numbers whereas the third plurality of numbers may include 24-bit numbers. The processor may be configured to determine, via the first set of hardware multipliers and not the second set of hardware multipliers, a third product of the third plurality of numbers in response to the obtained third indication of the third command. For example, the first set of hardware multipliers may include a single 32-bit by 32-bit hardware multiplier while the third set of hardware multipliers may include a single 24-bit by 24-bit hardware multiplier. The third command to multiply the third plurality of numbers may be a command to multiply two 24-bit numbers while the first command the multiply the first plurality of numbers may be a command to multiply two 32-bit numbers. By multiplying the two 24-bit numbers using a single 24-bit by 24-bit hardware multiplier, the processor may conserve power resources, as the 32-bit by 32-bit hardware multiplier may use more power than the 24-bit by 24-bit hardware multiplier. The processor may be configured to output the determined third product. To output the determined third product, the processor may output the determined third product to a component of the processor. To output the determined third product, the processor may be configured to store the determined third product to a memory of the processor or to an external memory.

Particular aspects of the subject matter described in this disclosure can be implemented to realize one or more of the following potential advantages. In some examples, by configuring a processor to use a first set of hardware multipliers of a first bit-size to perform a first operation, a second set of hardware multipliers of a second bit-size different than the first bit-size to perform a second operation, and both the first set of hardware multipliers and the second set of hardware multipliers to perform a third operation, the described techniques can be used to optimize the use of hardware devices to perform operations without wasting resources.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

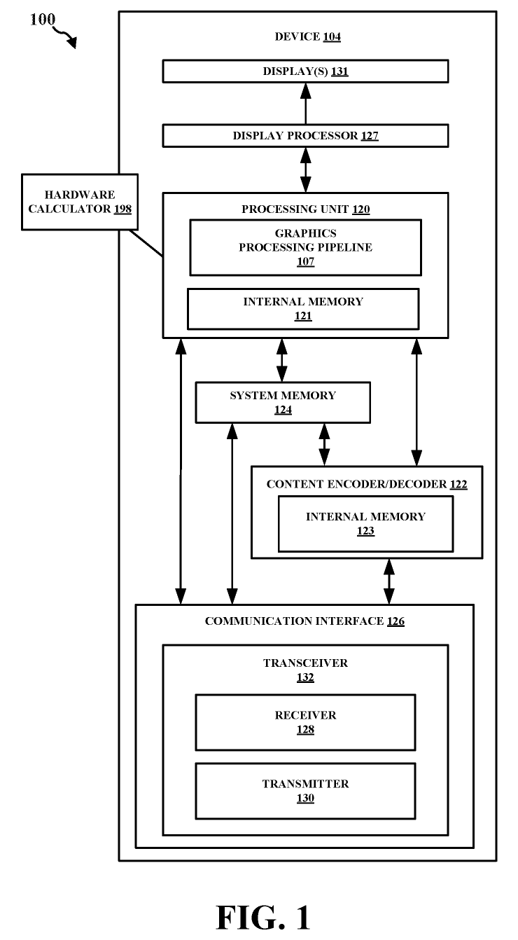

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors. A set of processors configured to perform a set of tasks may be configured to perform the set of tasks individually, or in any combination.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a hardware calculator 198 configured to obtain a first indication of a first command to multiply a first plurality of numbers or a second indication of a second command to add a plurality of products of a second plurality of numbers. The hardware calculator 198 may be configured to determine, via a first set of hardware multipliers, via a proper subset of a second set of hardware multipliers, and via a set of hardware adders, a first product of the first plurality of numbers in response to the obtained first indication of the first command. The hardware calculator 198 may be configured to determine, via the second set of hardware multipliers, the plurality of products of the second plurality of numbers in response to the obtained second indication of the second command. Each hardware multiplier of the first set of hardware multipliers may have a first multiplier path having a first bit-size. Each hardware multiplier of the second set of hardware multipliers may have a second multiplier path having a second bit-size, wherein the first bit-size and the second bit-size are not equal. The hardware calculator 198 may be configured to output the determined first product or a sum of the determined plurality of products. The hardware calculator 198 may also be referred to as an arithmetic logic unit (ALU). Although the following description may be focused on graphics processing, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

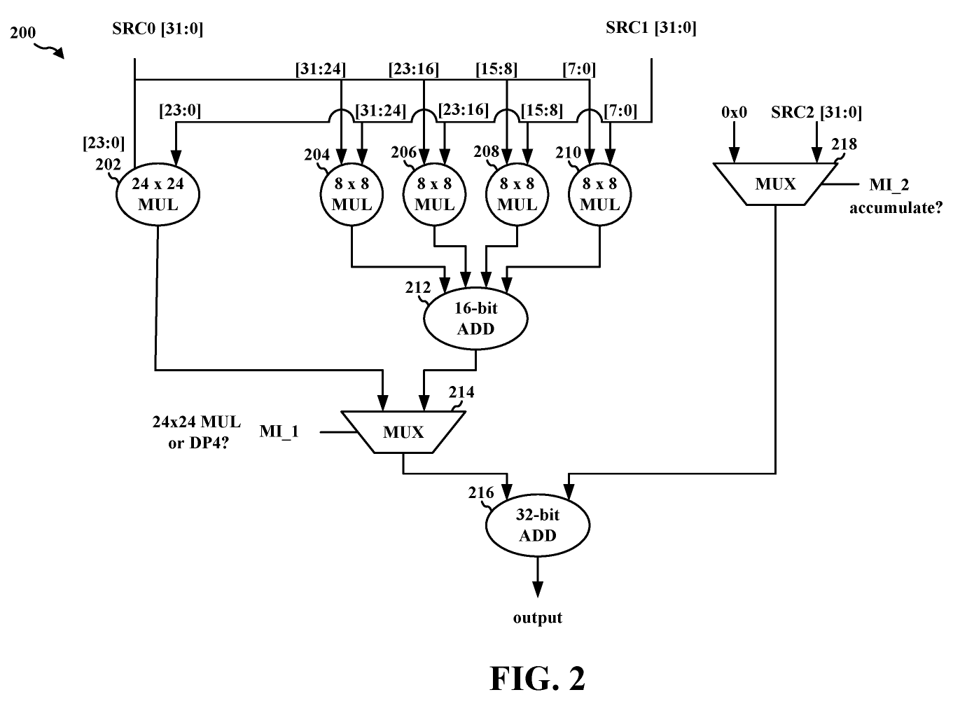

FIG. 2 is a diagram 200 of a set of hardware devices configured to perform different types of calculations on a set of numbers, in accordance with one or more techniques of this disclosure. The multiplier 202 may be a 24-bit by 24-bit multiplier (24x24 MUL) that multiplies two 24-bit numbers to calculate a product. The multiplier 204 may be an 8-bit by 8-bit multiplier (8x8 MUL) that multiplies two 8-bit numbers to calculate a product. The multiplier 206 may be an 8x8 MUL that multiplies two 8-bit numbers to calculate a product. The multiplier 208 may be an 8x8 MUL that multiplies two 8-bit numbers to calculate a product. The multiplier 210 may be an 8x8 MUL that multiplies two 8-bit numbers to calculate a product. The adder 212 may be a 16-bit adder (16-bit ADD, or 16+16+16+16 ADD) that adds four 16-bit numbers to calculate a sum. The multiplexor 214 may be a multiplexor that selects an input based on the MUX controller flag MI_1, where an unset bit selects the left input and a set bit selects the right input. The adder 216 may be a 32-bit by 32-bit adder (32+32 ADD) that adds two 32-bit numbers to calculate a sum. The multiplexor 218 may be a multiplexor that selects an input based on the MUX controller flag MI_2, where an unset bit selects the left input and a set bit selects the right input. While the hardware devices in FIG. 2 are shown as having operational paths with specific bit-sizes, for example a multiplier path for a multiplier, an adder path for an adder, or a selection path for a multiplexor, hardware devices may be used having larger or smaller bit-sizes to perform computations on inputs having other bit-sizes.

As shown, three input numbers may be provided to the set of hardware devices, shown here as three 32-bit input numbers SRC0[31:0], SRC1[31:0], and SRC2[31:0]. Each of the input numbers are shown in FIG. 2 as a stream of binary numbers that may be subdivided into components by bit number. For example, SRC0 may be a 32-bit number with the first eight most significant bits (MSBs) represented by SRC0[31:24] and the last eight least significant bits (LSBs) represented by SRC0[7:0].

The set of hardware devices in FIG. 2 may be configured to perform a multiplication of two 24-bit numbers (24x24 MUL), a multiplication of two 24-bit numbers followed by an accumulate (24x24 MUL_ACC), a DP4 of eight 8-bit numbers (8-bit DP4), or a DP4 of eight 8-bit numbers followed by an accumulate (8-bit DP4_ACC). A set of MUX controller flags, also referred to as a MUX instruction (MI), may indicate whether the set of hardware devices are directed to perform the 24x24 MUL, the 24x24 MUL_ACC, the 8-bit DP4, or the 8-bit DP4_ACC. In other words, the MUX controller flags MI_1 and MI_2 may control the set of hardware devices to perform a 24x24 MUL of SRC0[23:0] and SRC1[23:0], perform a 24x24 MUL_ACC of SRC0[23:0], SRC1[23:0], and SRC2[31:0], perform an 8-bit DP4 of SRC0[31:24], SRC1[31:24], SRC0[23:16], SRC1[23:16], SRC0[15:8], SRC1[15:8], SRC0[7:0], and SRC1[7:0], or perform an 8-bit DP4_ACC of SRC0[31:24], SRC1[31:24], SRC0[23:16], SRC1[23:16], SRC0[15:8], SRC1[15:8], SRC0[7:0], SRC1[7:0], and SRC2[31:0].

In one example, MI_1 may be unset to select the output of the multiplier 202, and MI_2 may be unset to select the input 0x0 (all zeros) of the multiplexor 218. This setting may perform a 24x24 MUL. The multiplier 202 may calculate the product of SRC0[23:0] and SRC1[23:0], which may be directed to the left input of the multiplexor 214. MI_1 of the multiplexor 214 may select the left input, which is the output of the multiplier 202. MI_2 of the multiplexor 218 may select the left input, which is the zeroed out bit input of 0x0. The adder 216 may add the output of the multiplexor 214 (i.e., the result of the 24x24 MUL) with the output of the multiplexor 218 (i.e., 0x0), which may result in an output which is the 24x24 MUL of SRC0[23:0] and SRC1[23:0].

In another example, MI_1 may be unset to select the output of the multiplier 202, and MI_2 may be set to select the right input SRC2 of the multiplexor 218. This setting may perform a 24x24 MUL_ACC. The multiplier 202 may calculate the product of SRC0[23:0] and SRC1[23:0], which may be directed to the left input of the multiplexor 214. MI_1 of the multiplexor 214 may select the left input, which is the output of the multiplier 202. MI_2 of the multiplexor 218 may select the right input, which is the 32-bit input SRC2, or SRC2[31:0]. The adder 216 may add the output of the multiplexor 214 (i.e., the result of the 24x24 MUL) with the output of the multiplexor 218 (i.e., SRC2[31:0]), which may result in an output which is the 24x24 MUL_ACC of SRC0[23:0], SRC1[23:0], and SRC2[31:0].

In another example, MI_1 may be set to select the output of the adder 212, and MI_2 may be unset to select the input 0x0 of the multiplexor 218. This setting may perform an 8-bit DP4. The multiplier 204 may calculate the product of SRC0[31:24] and SRC1[31:24], which may be directed to the first input of the adder 212. The multiplier 206 may calculate the product of SRC0[23:16] and SRC1[23:16], which may be directed to the second input of the adder 212. The multiplier 208 may calculate the product of SRC0[15:8] and SRC1[15:8], which may be directed to the third input of the adder 212. The multiplier 210 may calculate the product of SRC0[7:0] and SRC1[7:0], which may be directed to the fourth input of the adder 212. The adder 212 may add each of the four products to calculate a sum that is fed to the right input of the multiplexor 214. MI_1 of the multiplexor 214 may select the right input, which is the output of the adder 212. MI_2 of the multiplexor 218 may select the left input, which is the zeroed out bit input of 0x0. The adder 216 may add the output of the multiplexor 214 (i.e., the result of the 8-bit DP4) with the output of the multiplexor 218 (i.e., 0x0), which may result in an output which is the 8-bit DP4 of SRC0[31:24], SRC1[31:24], SRC0[23:16], SRC1[23:16], SRC0[15:8], SRC1[15:8], SRC0[7:0], and SRC1[7:0].

In another example, MI_1 may be set to select the output of the adder 212, and MI_2 may be set to select the right input SRC2 of the multiplexor 218. This setting may perform an 8-bit DP4_ACC. The multiplier 204 may calculate the product of SRC0[31:24] and SRC1[31:24], which may be directed to the first input of the adder 212. The multiplier 206 may calculate the product of SRC0[23:16] and SRC1[23:16], which may be directed to the second input of the adder 212. The multiplier 208 may calculate the product of SRC0[15:8] and SRC1[15:8], which may be directed to the third input of the adder 212. The multiplier 210 may calculate the product of SRC0[7:0] and SRC1[7:0], which may be directed to the fourth input of the adder 212. The adder 212 may add each of the four products to calculate a sum that is fed to the right input of the multiplexor 214. MI_1 of the multiplexor 214 may select the right input, which is the 32-bit input SRC2, or SRC2[31:0]. The adder 216 may add the output of the multiplexor 214 (i.e., the result of the 8-bit DP4) with the output of the multiplexor 218 (i.e., SRC2[31:0]),), which may result in an output which is the 8-bit DP4_ACC of SRC0[31:24], SRC1[31:24], SRC0[23:16], SRC1[23:16], SRC0[15:8], SRC1[15:8], SRC0[7:0], SRC1[7:0] and SRC2[31:0]).

A processor with the set of hardware devices in FIG. 2 may perform a 24x24 MUL or a 24x24 MUL_ACC, which may be used for performing multiplication on floating point (FP) or integer inputs. The same processor may also perform an 8-bit DP4 or an 8-bit DP4_ACC for machine learning (ML) applications. As an application may be configured to either perform graphics computations on a GPU, which may perform a large number of 24x24 MUL and/or 24x24 MUL_ACC operations, or perform ML computations on a GPU, which may perform a large number of 8-bit DP4 and/or 8-bit DP4_ACC operations, instructions that shut off DP4 hardware devices while using 24x24 MUL hardware devices, or that shut of 24x24 MUL hardware devices while using DP4 hardware devices, may improve power and resource efficiency.

While the set of hardware devices in FIG. 2 may efficiently perform a 24x24 MUL, a 24x24 MUL_ACC, an 8-bit DP4, and an 8-bit DP4_ACC, the set of hardware devices in FIG. 2 may not efficiently perform a 32x32 MUL of two 32-bit numbers. For example, in order to use the multiplier 202 to perform a 32x32 MUL of two 32-bit numbers SRC0[31:0] and SRC1[31:0], the multiplier 202 may be configured to multiply SRC0[15:0] and SRC1[15:0], then multiply SRC1[15:0] and SRC0[31:16] and accumulate the output from the previous operation, then multiply SRC0[15:0] and SRC1[31:16] and accumulate the output from the previous operation. While a three-instruction macro may be used to perform a 32x32 MUL of two 32-bit numbers by performing a 24x24 MUL on a first portion of two 32-bit input numbers, performing another 24x24 MUL on a second portion of the two 32-bit input numbers, performing another 24x24 MUL on a third portion of the two 32-bit input numbers, and adding the results, such a macro uses three cycles to compute, which is inefficient.

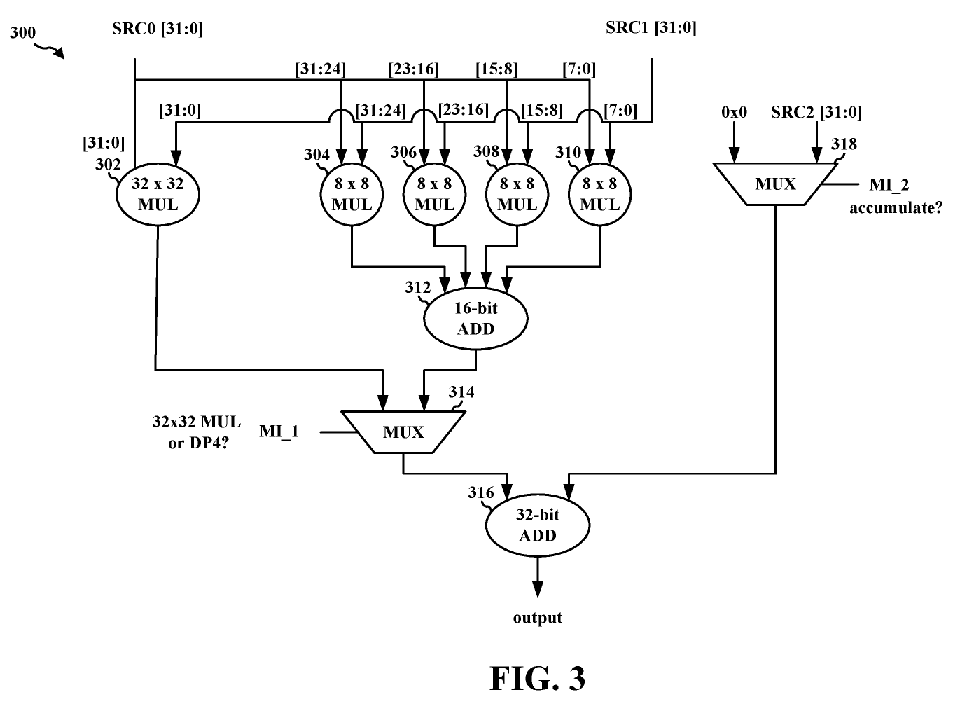

FIG. 3 is a diagram 300 of another set of hardware devices configured to perform different types of calculations on a set of numbers, in accordance with one or more techniques of this disclosure. The multiplier 302 may be a 32x32 multiplier (32x32 MUL) that multiplies two 32-bit numbers to calculate a product. The multiplier 304 may be an 8x8 MUL that multiplies two 8-bit numbers to calculate a product. The multiplier 306 may be an 8x8 MUL that multiplies two 8-bit numbers to calculate a product. The multiplier 308 may be an 8x8 MUL that multiplies two 8-bit numbers to calculate a product. The multiplier 310 may be an 8x8 MUL that multiplies two 8-bit numbers to calculate a product. The adder 312 may be a 16-bit ADD, also referred to as a 16+16+16+16 ADD, that adds four 16-bit numbers to calculate a sum. The multiplexor 314 may be a multiplexor that selects an input based on the MUX controller flag MI_1, where an unset bit selects the left input and a set bit selects the right input. The adder 316 may be a 32+32 ADD that adds two 32-bit numbers to calculate a sum. The multiplexor 318 may be a multiplexor that selects an input based on the MUX controller flag MI_2, where an unset bit selects the left input and a set bit selects the right input. While the hardware devices in FIG. 3 are shown as having operational paths with specific bit-sizes, for example a multiplier path for a multiplier, an adder path for an adder, or a selection path for a multiplexor, hardware devices may be used having larger or smaller bit-sizes to perform computations on inputs having other bit-sizes. Here, the multiplier 302 that can perform a 32x32 MUL effectively replaces the multiplier 202 in FIG. 2, allowing the set of hardware devices in FIG. 3 to perform a 24x24 MUL, a 24x24 MUL_ACC, a 32x32 MUL, a 32x32 MUL_ACC, an 8-bit DP4, and an 8-bit DP4_ACC. The 32x32 MUL has the same settings as the 24x24 MUL in FIG. 2, however the input numbers may have more bits. Similarly, the 32x32 MUL_ACC has the same settings as the 24x24 MUL_ACC in FIG. 2, however the input numbers may have more bits.

While the set of hardware devices in FIG. 2 may be configured to perform either a 24x24 MUL or a 32x32 MUL with the same settings, performing a multiplication of two 24-bit numbers with a 32x32 MUL may be inefficient, as the 32x32 MUL may use more power to add the two 24-bit numbers than the 24x24 MUL would. Moreover, the 32x32 MUL may take more time to add two 24-bit numbers slower than a 24x24 MUL would. In a processor with a plurality of such sets of hardware devices, these inefficiencies may add a great deal of latency and may waste power.

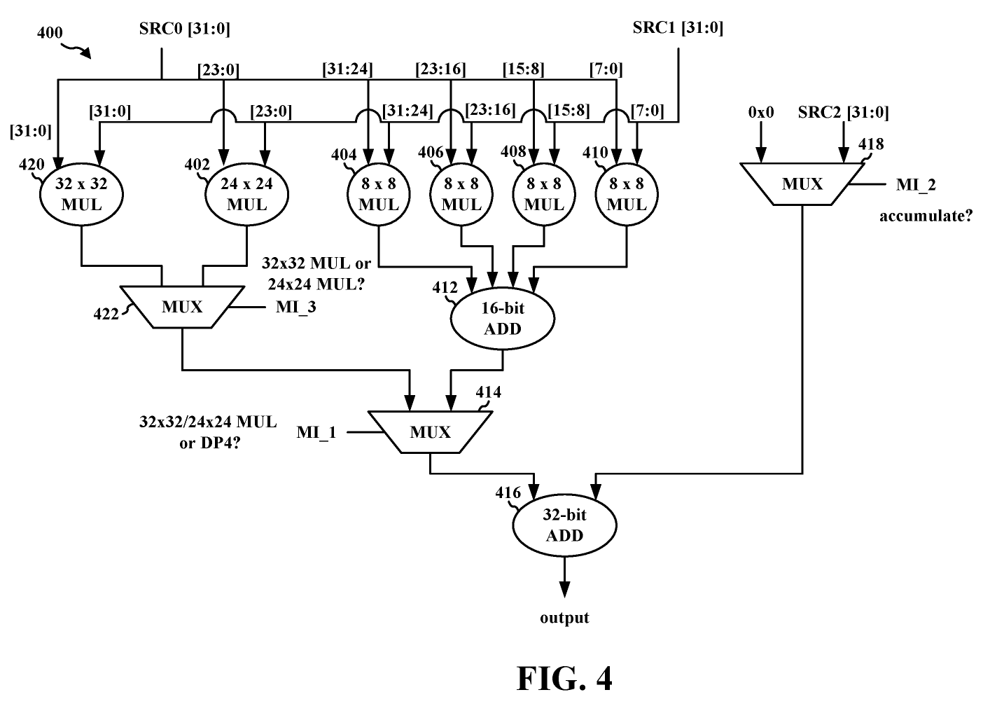

FIG. 4 is a diagram 400 of a set of hardware devices configured to perform different types of calculations on a set of numbers, in accordance with one or more techniques of this disclosure. The multiplier 402 may be a 24x24 MUL that multiplies two 24-bit numbers to calculate a product. The multiplier 404 may be an 8x8 MUL that multiplies two 8-bit numbers to calculate a product. The multiplier 406 may be an 8x8 MUL that multiplies two 8-bit numbers to calculate a product. The multiplier 408 may be an 8x8 MUL that multiplies two 8-bit numbers to calculate a product. The multiplier 410 may be an 8x8 MUL that multiplies two 8-bit numbers to calculate a product. The adder 412 may be a 16-bit ADD, also referred to as a 16+16+16+16 ADD, that adds four 16-bit numbers to calculate a sum. The multiplexor 414 may be a multiplexor that selects an input based on the MUX controller flag MI_1, where an unset bit selects the left input and a set bit selects the right input. The adder 416 may be a 32+32 ADD that adds two 32-bit numbers to calculate a sum. The multiplexor 418 may be a multiplexor that selects an input based on the MUX controller flag MI_2, where an unset bit selects the left input and a set bit selects the right input. The multiplier 420 may be a 32x32 MUL that multiplies two 32-bit numbers to calculate a product. The multiplexor 422 may be a multiplexor that selects an input based on the MUX controller flag MI_3, where an unset bit selects the left input and a set bit selects the right input. While the hardware devices in FIG. 4 are shown as having operational paths with specific bit-sizes, for example a multiplier path for a multiplier, an adder path for an adder, or a selection path for a multiplexor, hardware devices may be used having larger or smaller bit-sizes to perform computations on inputs having other bit-sizes. Here, the multiplier 420 may be used to efficiently multiply two 32-bit numbers while the multiplier 402 may be used to efficiently multiply two 24-bit numbers. The MUX controller flag MI_3 may be used to select between the 24x24 MUL and the 32x32 MUL.

As shown, three input numbers may be provided to the set of hardware devices, shown here as three 32-bit input numbers SRC0[31:0], SRC1[31:0], and SRC2[31:0]. The set of hardware devices in FIG. 4 may be configured to perform a 24x24 MUL, a 24x24 MUL_ACC, a 32x32 MUL, a 32x32 MUL_ACC, an 8-bit DP4, and an 8-bit DP4_ACC. A set of MUX controller flags, MI_1, MI_2, and MI_3, may indicate whether the set of hardware devices are directed to perform the 24x24 MUL, the 24x24 MUL_ACC, the 32x32 MUL, the 32x32 MUL_ACC, the 8-bit DP4, or the 8-bit DP4_ACC. In other words, the MUX controller flags MI_1, MI_2, and MI_3 may control the set of hardware devices to perform a 24x24 MUL of SRC0[23:0] and SRC1[23:0], perform a 24x24 MUL_ACC of SRC0[23:0], SRC1[23:0], and SRC2[31:0], perform a 32x32 MUL of SRC0[31:0] and SRC1[31:0], perform a 32x32 MUL_ACC of SRC0[31:0], SRC1[31:0], and SRC2[31:0], perform an 8-bit DP4 of SRC0[31:24], SRC1[31:24], SRC0[23:16], SRC1[23:16], SRC0[15:8], SRC1[15:8], SRC0[7:0], and SRC1[7:0], or perform an 8-bit DP4_ACC of SRC0[31:24], SRC1[31:24], SRC0[23:16], SRC1[23:16], SRC0[15:8], SRC1[15:8], SRC0[7:0], SRC1[7:0], and SRC2[31:0].

In one example, MI_1 may be unset to select the output of the multiplexor 422, MI_2 may be unset to select the left input 0x0 of the multiplexor 418, and MI_3 may be unset to select the output of the multiplier 420. This setting may perform a 32x32 MUL. The multiplier 420 may calculate the product of SRC0[31:0] and SRC1[31:0], which may be directed to the left input of the multiplexor 422. MI_3 of the multiplexor 422 may select the left input, which is the output of the multiplier 420. MI_1 of the multiplexor 414 may select the left input, which is the output of the multiplexor 422. MI_2 of the multiplexor 418 may select the left input, which is the zeroed out bit input of 0x0. The adder 416 may add the output of the multiplexor 414 (i.e., the result of the 32x32 MUL) with the output of the multiplexor 418 (i.e., 0x0), which may result in an output which is the 32x32 MUL of SRC0[31:0] and SRC1[31:0].

In another example, MI_1 may be unset to select the output of the multiplexor 422, MI_2 may be set to select the right input SRC2 of the multiplexor 418, and MI_3 may be unset to select the right input SRC2 of the multiplexor 418. This setting may perform a 32x32 MUL_ACC. The multiplier 420 may calculate the product of SRC0[31:0] and SRC1[31:0], which may be directed to the left input of the multiplexor 422. MI_3 of the multiplexor 422 may select the left input, which is the output of the multiplier 420. MI_1 of the multiplexor 414 may select the left input, which is the output of the multiplexor 422. MI_2 of the multiplexor 418 may select the right input, which is the 32-bit input SRC2, or SRC2[31:0]. The adder 416 may add the output of the multiplexor 414 (i.e., the result of the 32x32 MUL) with the output of the multiplexor 418 (i.e., SRC2[31:0]), which may result in an output which is the 32x32 MUL_ACC of SRC0[31:0], SRC1[31:0], and SRC2[31:0].

In another example, MI_1 may be unset to select the output of the multiplexor 422, MI_2 may be unset to select the input 0x0 of the multiplexor 418, and MI_3 may be set to select the output of the multiplier 402. This setting may perform a 24x24 MUL. The multiplier 402 may calculate the product of SRC0[23:0] and SRC1[23:0], which may be directed to the right input of the multiplexor 422. MI_3 of the multiplexor 422 may select the right input, which is the output of the multiplier 402. MI_1 of the multiplexor 414 may select the left input, which is the output of the multiplexor 422. MI_2 of the multiplexor 418 may select the left input, which is the zeroed out bit input of 0x0. The adder 416 may add the output of the multiplexor 414 (i.e., the result of the 24x24 MUL) with the output of the multiplexor 418 (i.e., 0x0), which may result in an output which is the 24x24 MUL of SRC0[23:0] and SRC1[23:0].

In another example, MI_1 may be unset to select the output of the multiplexor 422, MI_2 may be set to select the right input SRC2 of the multiplexor 418, and MI_3 may be set to select the output of the multiplier 402. This setting may perform a 24x24 MUL_ACC. The multiplier 402 may calculate the product of SRC0[23:0] and SRC1[23:0], which may be directed to the right input of the multiplexor 422. MI_3 of the multiplexor 422 may select the right input, which is the output of the multiplier 402. MI_1 of the multiplexor 414 may select the left input, which is the output of the multiplexor 422. MI_2 of the multiplexor 418 may select the right input, which is the 32-bit input SRC2, or SRC2[31:0]. The adder 416 may add the output of the multiplexor 414 (i.e., the result of the 24x24 MUL) with the output of the multiplexor 418 (i.e., SRC2[31:0]), which may result in an output which is the 24x24 MUL_ACC of SRC0[23:0], SRC1[23:0], and SRC2[31:0].

In another example, MI_1 may be set to select the output of the adder 412, and MI_2 may be unset to select the input 0x0 of the multiplexor 418. The setting of MI_3 would not matter in this example as the output to the multiplexor 422 is not selected by the multiplexor 414. This setting may perform an 8-bit DP4. The multiplier 404 may calculate the product of SRC0[31:24] and SRC1[31:24], which may be directed to the first input of the adder 412. The multiplier 406 may calculate the product of SRC0[23:16] and SRC1[23:16], which may be directed to the second input of the adder 412. The multiplier 408 may calculate the product of SRC0[15:8] and SRC1[15:8], which may be directed to the third input of the adder 412. The multiplier 410 may calculate the product of SRC0[7:0] and SRC1[7:0], which may be directed to the fourth input of the adder 412. The adder 412 may add each of the four products to calculate a sum that is fed to the right input of the multiplexor 414. MI_1 of the multiplexor 414 may select the right input, which is the output of the adder 412. MI_2 of the multiplexor 418 may select the left input, which is the zeroed out bit input of 0x0. The adder 416 may add the output of the multiplexor 414 (i.e., the result of the 8-bit DP4) with the output of the multiplexor 418 (i.e., 0x0), which may result in an output which is the 8-bit DP4 of SRC0[31:24], SRC1[31:24], SRC0[23:16], SRC1[23:16], SRC0[15:8], SRC1[15:8], SRC0[7:0], and SRC1[7:0].

In another example, MI_1 may be set to select the output of the adder 412, and MI_2 may be set to select SRC2 of the multiplexor 418. The setting of MI_3 would not matter in this example as the output to the multiplexor 422 is not selected by the multiplexor 414. This setting may perform an 8-bit DP4_ACC. The multiplier 404 may calculate the product of SRC0[31:24] and SRC1[31:24], which may be directed to the first input of the adder 412. The multiplier 406 may calculate the product of SRC0[23:16] and SRC1[23:16], which may be directed to the second input of the adder 412. The multiplier 408 may calculate the product of SRC0[15:8] and SRC1[15:8], which may be directed to the third input of the adder 412. The multiplier 410 may calculate the product of SRC0[7:0] and SRC1[7:0], which may be directed to the fourth input of the adder 412. The adder 412 may add each of the four products to calculate a sum that is fed to the right input of the multiplexor 414. MI_1 of the multiplexor 414 may select the right input, which is the 32-bit input SRC2, or SRC2[31:0]. The adder 416 may add the output of the multiplexor 414 (i.e., the result of the 8-bit DP4) with the output of the multiplexor 418 (i.e., SRC2[31:0]),), which may result in an output which is the 8-bit DP4_ACC of SRC0[31:24], SRC1[31:24], SRC0[23:16], SRC1[23:16], SRC0[15:8], SRC1[15:8], SRC0[7:0], SRC1[7:0] and SRC2[31:0]).

While the set of hardware devices in FIG. 4 may efficiently perform a 24x24 MUL, a 24x24 MUL_ACC, a 32x32 MUL, a 32x32 MUL_ACC, an 8-bit DP4, and an 8-bit DP4_ACC, the set of hardware devices in FIG. 4 may be quite a bit larger than the set of hardware devices in FIG. 2 or the set of hardware devices in FIG. 3. The set of hardware devices in FIG. 4 have an extra 32x32 MUL as compared with the set of hardware devices in FIG. 2, and have an extra 24x24 MUL as compared with the set of hardware devices in FIG. 3. While this configuration may be more power efficient and time efficient than the set of hardware devices in FIG. 3, the set of hardware devices in FIG. 4 is not space efficient. In a processor with a plurality of such sets of hardware devices, these inefficiencies may add a great deal of under-utilized multipliers in its processor design.

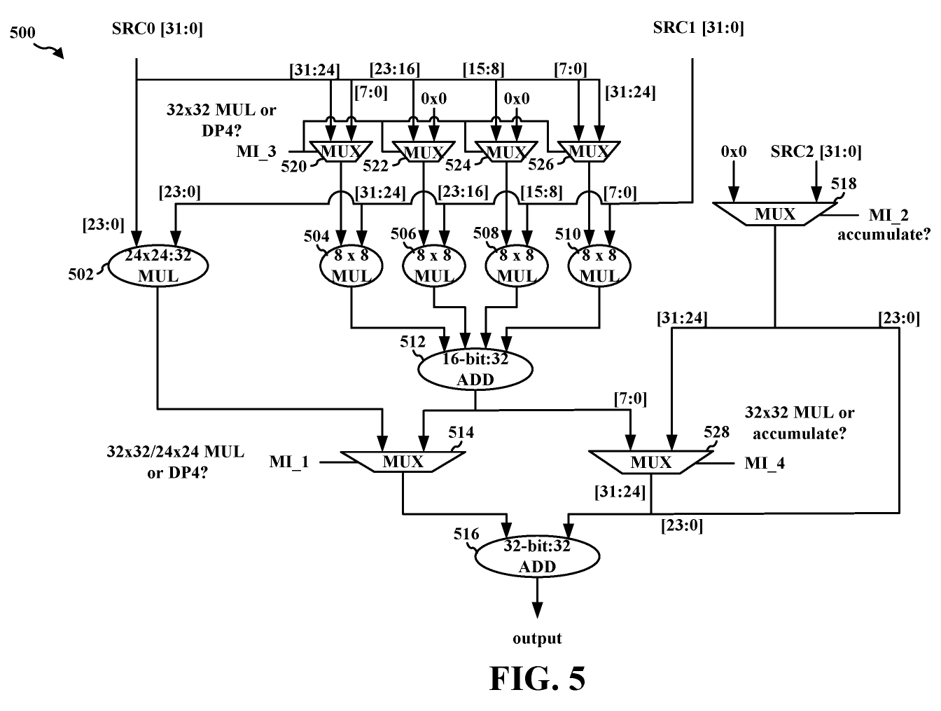

FIG. 5 is a diagram 500 of a set of hardware devices configured to perform different types of calculations on a set of numbers, in accordance with one or more techniques of this disclosure. The set of hardware devices may collectively be referred to as an ALU. The designator “___:N” is used to designate a hardware device configured to designate an output of an N bit-size that either truncates bits from the result, or zero-pads bits to the result. For example, an output result having a size of 48-bits with a “___:32” designator may truncate the 16 MSBs such that the output has a size of 32-bits, and an output result having a size of 16-bits with a “___:32” designator may pad the 16 MSBs with zeros such that the output has a size of 32-bits. In another example, a 24x24 MUL that multiplies two 24-bit numbers may calculate an output of 48 bits, but a 24x24:32 MUL that multiplies two 24-bit numbers may calculate an output of 32 bits, where the 16 MSBs of the resulting product are truncated. While, logically, the MSBs of a large-bit result (e.g., 48-bits) with a comparatively smaller-bit output (e.g., 32-bits) may be truncated, when building a hardware device with a smaller-bit output, the hardware device may be configured to simply not calculate a number of MSBs of the result to minimize waste.

The multiplier 502 may be a 24x24:32 MUL that multiplies two 24-bit numbers to calculate a 32-bit product, where the 16 MSBs of the 48-bit calculated product are truncated. The multiplier 504 may be an 8x8 MUL that multiplies two 8-bit numbers to calculate a 16-bit product. The multiplier 506 may be an 8x8 MUL that multiplies two 8-bit numbers to calculate a 16-bit product. The multiplier 508 may be an 8x8 MUL that multiplies two 8-bit numbers to calculate a 16-bit product. The multiplier 510 may be an 8x8 MUL that multiplies two 8-bit numbers to calculate a 16-bit product. The adder 512 may be a 16-bit:32 ADD, also referred to as a 16+16+16+16:32 AD, that adds four 16-bit numbers to calculate a 32-bit sum, where the 16 MSBs of the 18-bit calculated sum are padded with zeros to produce a 32-bit result. The multiplexor 514 may be a multiplexor that selects an input based on the MUX controller flag MI_1, where an unset bit selects the left input and a set bit selects the right input. The adder 516 may be a 32-bit:32 ADD, also referred to as a 32+32:32 ADD, that adds two 32-bit numbers to calculate a 32-bit sum, where the MSB of the 33-bit calculated sum is truncated. The multiplexor 518 may be a multiplexor that selects an input based on the MUX controller flag MI_2, where an unset bit selects the left input and a set bit selects the right input. The multiplexor 520 may be a multiplexor that selects an input based on the MUX controller flag MI_3, where an unset bit selects the left input and a set bit selects the right input. The multiplexor 522 may be a multiplexor that selects an input based on the MUX controller flag MI_3, where an unset bit selects the left input and a set bit selects the right input. The multiplexor 524 may be a multiplexor that selects an input based on the MUX controller flag MI_3, where an unset bit selects the left input and a set bit selects the right input. The multiplexor 526 may be a multiplexor that selects an input based on the MUX controller flag MI_3, where an unset bit selects the left input and a set bit selects the right input. The multiplexor 528 may be a multiplexor that selects an input based on the MUX controller flag MI_4, where an unset bit selects the left input and a set bit selects the right input. While the hardware devices in FIG. 5 are shown as having operational paths with specific bit-sizes, for example a multiplier path for a multiplier, an adder path for an adder, or a selection path for a multiplexor, hardware devices may be used having larger or smaller bit-sizes to perform computations on inputs having other bit-sizes. Here, the multiplier 504 and the multiplier 510 may be configured to either perform multiplication to calculate products for an 8-bit DP4 and/or an 8-bit DP4_ACC, or to perform multiplication to calculate products for a 32x32 MUL. The MUX controller flag MI_3 may be used to select between the products for an 8-bit DP4/DP4_ACC operation, or to select the products for a 32x32 MUL operation. Similarly, the MUX controller flag MI_4 may be used to select between a possible accumulate operation, or a sum that may be used to calculate a 32x32 MUL operation.

As shown, three input numbers may be provided to the set of hardware devices, shown here as three 32-bit input numbers SRC0[31:0], SRC1[31:0], and SRC2[31:0]. The set of hardware devices in FIG. 5 may be configured to perform a 24x24 MUL, a 24x24 MUL_ACC, a 32x32 MUL, an 8-bit DP4, and an 8-bit DP4_ACC. A set of MUX controller flags, MI_1, MI_2, MI_3, and MI_4, may indicate whether the set of hardware devices are directed to perform the 24x24 MUL, the 24x24 MUL_ACC, the 32x32 MUL, the 8-bit DP4, or the 8-bit DP4_ACC. In other words, the MUX controller flags MI_1, MI_2, MI_3, and MI_4 may control the set of hardware devices to perform a 24x24 MUL of SRC0[23:0] and SRC1[23:0], perform a 24x24 MUL_ACC of SRC0[23:0], SRC1[23:0], and SRC2[31:0], perform a 32x32 MUL of SRC0[31:0] and SRC1[31:0], perform an 8-bit DP4 of SRC0[31:24], SRC1[31:24], SRC0[23:16], SRC1[23:16], SRC0[15:8], SRC1[15:8], SRC0[7:0], and SRC1[7:0], or perform an 8-bit DP4_ACC of SRC0[31:24], SRC1[31:24], SRC0[23:16], SRC1[23:16], SRC0[15:8], SRC1[15:8], SRC0[7:0], SRC1[7:0], and SRC2[31:0].

In one example, MI_1 may be unset to select the output of the multiplier 502, MI_2 may be unset to select the left input 0x0 of the multiplexor 518, and MI_4 may be set to select the 8 MSBs of the output of the multiplexor 518. The setting of MI_3 would not matter in this example as the output to the adder 512 is not selected by the multiplexor 514 or the multiplexor 528. This setting may perform a 24x24 MUL. The multiplier 502 may calculate the product of SRC0[23:0] and SRC1[23:0], which may be directed to the left input of the multiplexor 514. MI_1 of the multiplexor 514 may select the left input, which is the output of the multiplier 502. MI_2 of the multiplexor 518 may select the left input, which is the zeroed out bit input of 0x0. MI_4 may select the 8 MSBs (i.e., bits [31:24]) of the output of the multiplexor 518. The 24 LSBs (i.e., bits [23:0]) of the output of the multiplexor 518 may be directed to the 24 LSBs (i.e., bits [23:0]) of the right input of the adder 516, while the output of the multiplexor 528 may be directed to the 8 MSBs (i.e., bits [31:24]) of the right input of the adder 516. The adder 516 may add the output of the multiplexor 514 (i.e., the result of the 24x24 MUL) to an input having the 8 MSBs obtained from the output of the multiplexor 528 (i.e., 0x0) and the 24 LSBs obtained from the output of the multiplexor 518 (i.e., 0x0), which may result in an output which is the 24x24 MUL of SRC0[23:0] and SRC1[23:0].

In another example, MI_1 may be unset to select the output of the multiplier 502, MI_2 may be set to select the right input SRC2 of the multiplexor 518, and MI_4 may be set to select the 8 MSBs of the output of the multiplexor 518. The setting of MI_3 would not matter in this example as the output to the adder 512 is not selected by the multiplexor 514 or the multiplexor 528. This setting may perform a 24x24 MUL_ACC. The multiplier 502 may calculate the product of SRC0[23:0] and SRC1[23:0], which may be directed to the left input of the multiplexor 514. MI_1 of the multiplexor 514 may select the left input, which is the output of the multiplier 502. MI_2 of the multiplexor 518 may select the right input, which is the 32-bit input SRC2, or SRC2[31:0]. MI_4 may select the upper 8 bits (i.e., bits [31:24]) of the output of the multiplexor 518. The lower bits (i.e., bits [23:0]) of the output of the multiplexor 518 may be directed to the lower bits (i.e., bits [23:0]) of the right input of the adder 516, while the output of the multiplexor 528 may be directed to the upper bits (i.e., bits [31:24]) of the right input of the adder 516. The adder 516 may add the output of the multiplexor 514 (i.e., the result of the 24x24 MUL) with an input having the upper 8 bits from the output of the multiplexor 528 (i.e., SRC2[31:24]) and the lower 24 bits from the output of the multiplexor 518 (i.e., SRC2[23:0]), which may result in an output which is the 24x24 MUL_ACC of SRC0[23:0], SRC1[23:0], and SRC2[31:0].

In another example, MI_1 may be unset to select the output of the multiplier 502. MI_2 may be unset to select the left input 0x0 of the multiplexor 518. MI_3 may be set to select the right input to the multiplexor 520 (i.e., SRC0[7:0]), the right input to the multiplexor 522 (i.e., 0x0), the right input to the multiplexor 524 (i.e., 0x0), and the right input to the multiplexor 526 (i.e., SRC0[31:24]). MI_4 may be unset to select the 8 LSBs of the output to the adder 512. This setting may perform a 32x32 MUL. The multiplier 502 may calculate the product of SRC0[23:0] and SRC1[23:0], which may be directed to the left input of the multiplexor 514. MI_3 of the multiplexor 520 may select the right input, which is SRC0[7:0]. The multiplier 504 may calculate the product of SRC0[7:0] and SRC1[31:24], which may be directed to the first input of the adder 512. MI_3 of the multiplexor 522 may select the right input, which is 0x0. The multiplier 506 may calculate the product of 0x0 and SRC1[23:16], which may be 0x0, and may be directed to the second input of the adder 512. MI_3 of the multiplexor 524 may select the right input, which is 0x0. The multiplier 508 may calculate the product of 0x0 and SRC1[15:8], which may be 0x0, and may be directed to the third input of the adder 512. MI_3 of the multiplexor 526 may select the right input, which is SRC0[31:24]. The multiplier 510 may calculate the product of SRC0[31:24] and SRC1[7:0], which may be directed to the fourth input of the adder 512. The adder 512 may add each of the four products to calculate a sum that is fed to the right input of the multiplexor 514 and the left input of the multiplexor 528. Since the output of the multiplier 506 and the multiplier 508 are both 0x0, the sum of the adder 512 may be the output of the multiplier 504 (i.e., the product of SRC0[7:0] and SRC1[31:24]) added to the output of the multiplier 510 (i.e., the product of SRC0[31:24] and SRC1[7:0]). MI_1 of the multiplexor 514 may select the left input, so the output of the adder 512 to the multiplexor 514 may be ignored. However, MI_4 may select the 8 LSBs (i.e., bits [7:0]) of the output of the adder 512. MI_2 may select the left input 0x0 of the multiplexor 518. The 24 LSBs (i.e., bits [23:0]) of the output of the multiplexor 518 may be directed to the 24 LSBs (i.e., bits [23:0]) of the right input of the adder 516, while the output of the multiplexor 528 may be directed to the 8 MSBs (i.e., bits [31:24]) of the right input of the adder 516. Since the output of the multiplexor 518 is 0x0, and the 8 LSBs of the output of the adder 512 is calculated as the sum of the product of SRC0[7:0] and SRC1[31:24] and the product of SRC0[31:24] and SRC1[7:0], the right input to the adder 516 is the sum of the product of SRC0[7:0] and SRC1[31:24] and the product of SRC0[31:24] and SRC1[7:0] left shifted by 24 bits. In other words, the right input to the adder 516 is (((SRC0[7:0] × SRC1[31:24]) + (SRC0[31:24] × SRC1[7:0])) << 24). The adder 516 may add the output of the multiplexor 514 (i.e., the result of the 24x24 MUL) to an input having the 8 MSBs obtained from the output of the multiplexor 528 (i.e., 0x0) and the 24 LSBs obtained from the output of the multiplexor 518 (i.e., ((SRC0[7:0] × SRC1[31:24]) + (SRC0[31:24] × SRC1[7:0]))), which may result in an output which is the 32x32 MUL of SRC0[31:0] and SRC1[31:0]. The complete formula of the adder 516 may also be represented by (SRC0[23:0] × SRC1[23:0]) + (((SRC0[7:0] × SRC1[31:24]) + (SRC0[31:24] × SRC1[7:0])) << 24).

In another example, MI_1 may be set to select the output of the adder 512. MI_2 may be unset to select the left input 0x0 of the multiplexor 518. MI_3 may be unset to select the left input to the multiplexor 520 (i.e., SRC0[31:24]), the left input to the multiplexor 522 (i.e., SRC0[23:16]), the left input to the multiplexor 524 (i.e., SRC0[15:8]), and the left input to the multiplexor 526 (i.e., SRC0[7:0]). MI_4 may be set to select the 8 MSBs of the output of the multiplexor 518. This setting may perform an 8-bit DP4. MI_b of the multiplexor 520 may select the left input, which is SRC0[31:24]. The multiplier 504 may calculate the product of SRC0[31:24] and SRC1[31:24], which may be directed to the first input of the adder 512. MI_3 of the multiplexor 522 may select the left input, which is SRC0[23:16]. The multiplier 506 may calculate the product of SRC0[23:16] and SRC1[23:16], which may be directed to the second input of the adder 512. MI_3 of the multiplexor 524 may select the left input, which is SRC0[15:8]. The multiplier 508 may calculate the product of SRC0[15:8] and SRC1[15:8], which may be directed to the third input of the adder 512. MI_3 of the multiplexor 526 may select the left input, which is SRC0[7:0]. The multiplier 510 may calculate the product of SRC0[7:0] and SRC1[7:0], which may be directed to the fourth input of the adder 512. The adder 512 may add each of the four products to calculate a sum that is fed to the right input of the multiplexor 514 and the left input of the multiplexor 528. MI_1 of the multiplexor 514 may select the right input, which is the output of the adder 512. Since MI_4 of the multiplexor 528 may select the 8 MSBs (i.e., bits [31:24]) of the output of the multiplexor 518, the output of the multiplexor 528 is directed to the 8 MSBs (i.e., bits [31:24]) of the right input to the adder 516, and the 24 LSBs of the output of the multiplexor 518 are directed to the 24 LSBs (i.e., bits [23:0]) of the right input to the adder, the right input to the adder 516 is simply the output of the multiplexor 518. Since MI_2 of the multiplexor 518 may select the left input, which is the zeroed out bit input of 0x0, the right input to the adder 516 is 0x0. The adder 516 may add the output of the multiplexor 514 (i.e., the result of the 8-bit DP4) to an input having the 8 MSBs obtained from the output of the multiplexor 528 (i.e., 0x0) and the 24 LSBs obtained from the output of the multiplexor 518 (i.e., 0x0), which may result in an output which is the 8-bit DP4 of SRC0[31:24], SRC1[31:24], SRC0[23:16], SRC1[23:16], SRC0[15:8], SRC1[15:8], SRC0[7:0], and SRC1[7:0].

In another example, MI_1 may be set to select the output of the adder 512. MI_2 may be set to select the right input SRC2 of the multiplexor 518. MI_3 may be unset to select the left input to the multiplexor 520 (i.e., SRC0[31:24]), the left input to the multiplexor 522 (i.e., SRC0[23:16]), the left input to the multiplexor 524 (i.e., SRC0[15:8]), and the left input to the multiplexor 526 (i.e., SRC0[7:0]). MI_4 may be set to select the 8 MSBs of the output of the multiplexor 518. This setting may perform an 8-bit DP4_ACC. MI_3 of the multiplexor 520 may select the left input, which is SRC0[31:24]. The multiplier 504 may calculate the product of SRC0[31:24] and SRC1[31:24], which may be directed to the first input of the adder 512. MI_3 of the multiplexor 522 may select the left input, which is SRC0[23:16]. The multiplier 506 may calculate the product of SRC0[23:16] and SRC1[23:16], which may be directed to the second input of the adder 512. MI_3 of the multiplexor 524 may select the left input, which is SRC0[15:8]. The multiplier 508 may calculate the product of SRC0[15:8] and SRC1[15:8], which may be directed to the third input of the adder 512. MI_3 of the multiplexor 526 may select the left input, which is SRC0[7:0]. The multiplier 510 may calculate the product of SRC0[7:0] and SRC1[7:0], which may be directed to the fourth input of the adder 512. The adder 512 may add each of the four products to calculate a sum that is fed to the right input of the multiplexor 514 and the left input of the multiplexor 528. MI_1 of the multiplexor 514 may select the right input, which is the output of the adder 512. MI_2 of the multiplexor 518 may select the right input, which is the 32-bit input SRC2, or SRC2[31:0]. MI_4 of the multiplexor 528 may select the 8 MSBs (i.e., bits [31:24]) of the output of the multiplexor 518 (i.e., SRC2[31:24]). Since MI_4 of the multiplexor 528 may select the 8 MSBs (i.e., bits [31:24]) of the output of the multiplexor 518, the output of the multiplexor 528 is directed to the 8 MSBs (i.e., bits [31:24]) of the right input to the adder 516, and the 24 LSBs of the output of the multiplexor 518 are directed to the 24 LSBs (i.e., bits [23:0]) of the right input to the adder, the right input to the adder 516 is simply the output of the multiplexor 518. Since MI_2 of the multiplexor 518 may select the right input, which is SRC2[31:0], the right input to the adder 516 is SRC2[31:0]. The adder 516 may add the output of the multiplexor 514 (i.e., the result of the 8-bit DP4) to an input having the 8 MSBs obtained from the output of the multiplexor 528 (i.e., SRC2[31:24]) and the 24 LSBs obtained from the output of the multiplexor 518 (i.e., SRC2[23:0]), which may result in an output which is the 8-bit DP4_ACC of SRC0[31:24], SRC1[31:24], SRC0[23:16], SRC1[23:16], SRC0[15:8], SRC1[15:8], SRC0[7:0], SRC1[7:0] and SRC2[31:0]).

The set of hardware devices in FIG. 5 may efficiently perform a 24x24 MUL, a 24x24 MUL_ACC, a 32x32 MUL, an 8-bit DP4, and an 8-bit DP4_ACC. The low cost swizzle of selecting a subset of the SRC0 bits using the multiplexor 520 and the multiplexor 526 allows the 8-bit DP4 logic (i.e., the multiplier 504, the multiplier 506, the multiplier 508, and the multiplier 510) to produce the MSBs of the product of SRC0[31:0] and SRC1[31:0] while using the accumulator logic to add the product of SRC0[23:0] and SRC1[23:0] to the MSBs of the product of SRC0[31:0] and SRC1[31:0] (i.e., ((SRC0[7:0] × SRC1[31:24]) + (SRC0[31:24] × SRC1[7:0]))). The added multiplexors (i.e., the multiplexor 520, the multiplexor 522, the multiplexor 524, the multiplexor 526, and the multiplexor 528) are also much cheaper, real estate-wise, than either expanding a 24x24 MUL into a 32x32 MUL, or adding a new 32x32 MUL to the set of hardware devices in FIG. 2. In other words, the space used by the added multiplexors in FIG. 5 is less than the extra space used by the multiplier 302 in FIG. 3 as compared to the multiplier 202 in FIG. 2, and is less than the extra space used by the multiplier 420 in FIG. 4. Moreover, the added multiplexors in FIG. 5 do not use much power or add much latency as compared to multipliers.

However, the set of hardware devices in FIG. 5 utilizes the accumulator logic to add the product of SRC0[23:0] and SRC1[23:0] to the MSBs of the product of SRC0[31:0] and SRC1[31:0] (i.e., ((SRC0[7:0] × SRC1[31:24]) + (SRC0[31:24] × SRC1[7:0]))). As a result, the set of hardware devices in FIG. 5 are unable to perform a 32x32 MUL_ACC.

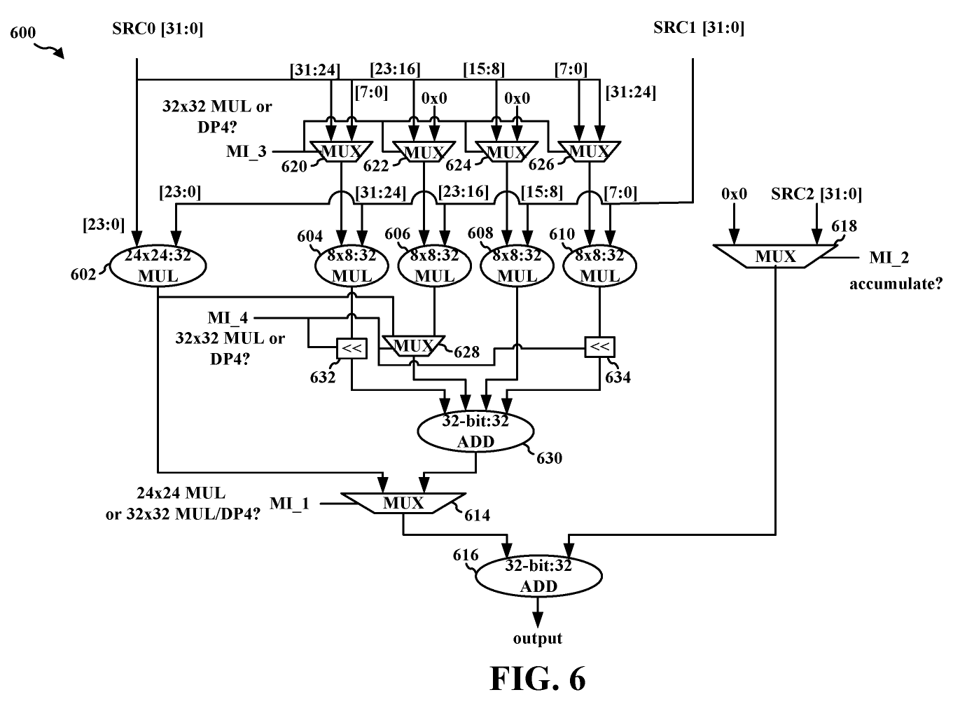

FIG. 6 is a diagram 600 of a set of hardware devices configured to perform different types of calculations on a set of numbers, in accordance with one or more techniques of this disclosure. The set of hardware devices may be collectively referred to as an ALU. The multiplier 602 may be a 24x24:32 MUL that multiplies two 24-bit numbers to calculate a 32-bit product, where the 16 MSBs of the 48-bit calculated product are truncated. The multiplier 604 may be an 8x8:32 MUL that multiplies two 8-bit numbers to calculate a 32-bit product, where the 16 MSBs of the 16-bit calculated product are zero padded to produce a 32-bit output. The multiplier 606 may be an 8x8:32 MUL that multiplies two 8-bit numbers to calculate a 32-bit product, where the 16 MSBs of the 16-bit calculated product are zero padded to produce a 32-bit output. The multiplier 608 may be an 8x8:32 MUL that multiplies two 8-bit numbers to calculate a 32-bit product, where the 16 MSBs of the 16-bit calculated product are zero padded to produce a 32-bit output. The multiplier 610 may be an 8x8:32 MUL that multiplies two 8-bit numbers to calculate a 32-bit product, where the 16 MSBs of the 16-bit calculated product are zero padded to produce a 32-bit output. The multiplexor 614 may be a multiplexor that selects an input based on the MUX controller flag MI_1, where an unset bit selects the left input and a set bit selects the right input. The adder 616 may be a 32+32 ADD, that adds two 32-bit numbers to calculate a 32-bit sum, where the MSB of the 33-bit calculated sum is truncated. The multiplexor 618 may be a multiplexor that selects an input based on the MUX controller flag MI_2, where an unset bit selects the left input and a set bit selects the right input. The multiplexor 620 may be a multiplexor that selects an input based on the MUX controller flag MI_3, where an unset bit selects the left input and a set bit selects the right input. The multiplexor 622 may be a multiplexor that selects an input based on the MUX controller flag MI_3, where an unset bit selects the left input and a set bit selects the right input. The multiplexor 624 may be a multiplexor that selects an input based on the MUX controller flag MI_3, where an unset bit selects the left input and a set bit selects the right input. The multiplexor 626 may be a multiplexor that selects an input based on the MUX controller flag MI_3, where an unset bit selects the left input and a set bit selects the right input. The multiplexor 628 may be a multiplexor that selects an input based on the MUX controller flag MI_4, where an unset bit selects the left input and a set bit selects the right input. The adder 630 may be a 32-bit:32 ADD, also referred to as a 32+32+32+32:32 ADD, that adds four 32-bit numbers to calculate a sum, where the 2 MSBs of the 34-bit calculated sum is truncated. The shifter 632 may be a hardware module that determines whether to left shift the output from the multiplier 604 by 24 bits based on the MUX controller flag MI_4, where an unset bit results in left-shifting the output from the multiplier 604 by 24 bits and a set bit results in not left-shifting the output from the multiplier 604 by 24 bits. The shifter 634 may be a hardware module that determines whether to left shift the output from the multiplier 610 by 24 bits based on the MUX controller flag MI_4, where an unset bit results in left-shifting the output from the multiplier 610 by 24 bits and a set bit results in not left-shifting the output from the multiplier 610 by 24 bits. While the hardware devices in FIG. 6 are shown as having operational paths with specific bit-sizes, for example a multiplier path for a multiplier, an adder path for an adder, or a selection path for a multiplexor, hardware devices may be used having larger or smaller bit-sizes to perform computations on inputs having other bit-sizes. Moreover, while the multiplexor 628 is shown connected to the output of the multiplier 606, the multiplexor 628 may alternatively be connected to the output of the multiplier 608 instead of the output of the multiplier 606 in other aspects. Here, the multiplier 604 and the multiplier 610 may be configured to either perform multiplication to calculate products for an 8-bit DP4 and/or an 8-bit DP4_ACC, or to perform multiplication to calculate products for a 32x32 MUL and/or a 32x32 MUL_ACC, and the second input to the adder 630 may be used to add the output of the multiplier 602 to the output of the multiplier 604 and the output of the multiplier 610. The MUX controller flag MI_3 may be used to select between the products for an 8-bit DP4/DP4_ACC operation, or to select the products for a 32x32 MUL/MUL_ACC operation. The MUX controller flag MI_4 may be used to select between an 32x32 MUL/MUL_ACC operation, or an 8-bit DP4/DP4_ACC operation.

As shown, three input numbers may be provided to the set of hardware devices, shown here as three 32-bit input numbers SRC0[31:0], SRC1[31:0], and SRC2[31:0]. The set of hardware devices in FIG. 6 may be configured to perform a 24x24 MUL, a 24x24 MUL_ACC, a 32x32 MUL, a 32x32 MUL_ACC, an 8-bit DP4, and an 8-bit DP4_ACC. A set of MUX controller flags, MI_1, MI_2, MI_3, and MI_4, may indicate whether the set of hardware devices are directed to perform the 24x24 MUL, the 24x24 MUL_ACC, the 32x32 MUL, the MUL_ACC, the 8-bit DP4, or the 8-bit DP4_ACC. In other words, the MUX controller flags MI_1, MI_2, MI_3, and MI_4 may control the set of hardware devices to perform a 24x24 MUL of SRC0[23:0] and SRC1[23:0], perform a 24x24 MUL_ACC of SRC0[23:0], SRC1[23:0], and SRC2[31:0], perform a 32x32 MUL of SRC0[31:0] and SRC1[31:0], perform a 32x32 MUL of SRC0[31:0], SRC1[31:0], and SRC2[31:0], perform an 8-bit DP4 of SRC0[31:24], SRC1[31:24], SRC0[23:16], SRC1[23:16], SRC0[15:8], SRC1[15:8], SRC0[7:0], and SRC1[7:0], or perform an 8-bit DP4_ACC of SRC0[31:24], SRC1[31:24], SRC0[23:16], SRC1[23:16], SRC0[15:8], SRC1[15:8], SRC0[7:0], SRC1[7:0], and SRC2[31:0].

In one example, MI_1 may be unset to select the output of the multiplier 602, MI_2 may be unset to select the left input 0x0 of the multiplexor 618. The setting of MI_3 and MI_4 would not matter in this example as the output to the adder 630 is not selected by the multiplexor 614. This setting may perform a 24x24 MUL. The multiplier 602 may calculate the product of SRC0[23:0] and SRC1[23:0], which may be directed to the left input of the multiplexor 614 and to the left input of the multiplexor 628. MI_1 of the multiplexor 614 may select the left input, which is the output of the multiplier 602. MI_2 of the multiplexor 618 may select the left input, which is the zeroed out bit input of 0x0. The adder 616 may add the output of the multiplexor 614 (i.e., the result of the 24x24 MUL) to the output of the multiplexor 618 (i.e., 0x0), which may result in an output which is the 24x24 MUL of SRC0[23:0] and SRC1[23:0].

In another example, MI_1 may be unset to select the output of the multiplier 602, MI_2 may be set to select the right input SRC2 of the multiplexor 618. The setting of MI_3 and MI_4 would not matter in this example as the output to the adder 630 is not selected by the multiplexor 614. This setting may perform a 24x24 MUL_ACC. The multiplier 602 may calculate the product of SRC0[23:0] and SRC1[23:0], which may be directed to the left input of the multiplexor 614 and to the left input of the multiplexor 628. MI_1 of the multiplexor 614 may select the left input, which is the output of the multiplier 602. MI_2 of the multiplexor 618 may select the right input, which is the 32-bit input SRC2, or SRC2[31:0]. The adder 616 may add the output of the multiplexor 614 (i.e., the result of the 24x24 MUL) with the output of the multiplexor 618 (i.e., SRC2[31:0]), which may result in an output which is the 24x24 MUL_ACC of SRC0[23:0], SRC1[23:0], and SRC2[31:0].

In another example, MI_1 may be set to select the output of the adder 630. MI_2 may be unset to select the left input 0x0 of the multiplexor 618. MI_3 may be set to select the right input to the multiplexor 620 (i.e., SRC0[7:0]), the right input to the multiplexor 622 (i.e., 0x0), the right input to the multiplexor 624 (i.e., 0x0), and the right input to the multiplexor 626 (i.e., SRC0[31:24]). MI_4 may be unset to select the output of the multiplier 602 for the multiplexor 628, to left-shift the output of the multiplier 604 by 24-bits for the shifter 632, and to left-shift the output of the multiplier 610 by 24-bits for the shifter 634. This setting may perform a 32x32 MUL. The multiplier 602 may calculate the product of SRC0[23:0] and SRC1[23:0], which may be directed to the left input of the multiplexor 614 and to the left input of the multiplexor 628. MI_3 of the multiplexor 620 may select the right input, which is SRC0[7:0]. The multiplier 604 may calculate the product of SRC0[7:0] and SRC1[31:24], which may be directed to the shifter 632. MI_4 of the shifter 632 may select to left shift the output of the multiplier 604 by 24 bits, such that the 8 LSBs (i.e., [7:0]) of the output of the multiplier 604 are directed to the8 MSBs (i.e., [31:24]) of the first input of the adder 630. The shifter 632 may pad the 24 LSBs (i.e., [23:0]) of the 32-bit first input of the adder 630 with zeroes. MI_3 of the multiplexor 622 may select the right input, which is 0x0. The multiplier 606 may calculate the product of 0x0 and SRC1[23:16], which may be 0x0, and may be directed to the right input of the multiplexor 628. MI_4 of the multiplexor 628 may select the output of the multiplier 602, which may be directed to the 32-bit second input of the adder 630. MI_3 of the multiplexor 624 may select the right input, which is 0x0. The multiplier 608 may calculate the product of 0x0 and SRC1[15:8], which may be 0x0, which may be directed to the 32-bit third input of the adder 630. MI_3 of the multiplexor 626 may select the right input, which is SRC0[31:24]. The multiplier 610 may calculate the product of SRC0[31:24] and SRC1[7:0], which may be directed to the shifter 634. MI_4 of the shifter 634 may select to left shift the output of the multiplier 610 by 24 bits, such that the8 LSBs (i.e., [7:0]) of the output of the multiplier 610 are directed to the 8 MSBs (i.e., [31:24]) of the fourth input of the adder 630. The shifter 634 may pad the 24 LSBs (i.e., [23:0]) of the 32-bit fourth input of the adder 630 with zeroes. The adder 630 may add each of the four inputs to calculate a sum that is fed to the right input of the multiplexor 614. Since the output of the multiplier 608 is 0x0, the sum of the adder 630 may be the left-shifted output of the multiplier 604 (i.e., ((SRC0[7:0] × SRC1[31:24]) << 24)), the left-shifted output of the multiplier 610 (i.e., ((SRC0[31:24] × SRC1[7:0]) << 24)), and the output of the multiplexor 628 (e.g., the product of SRC0[23:0] and SRC1[23:0]). The complete formula of the adder 516 may also be represented by (SRC0[23:0] × SRC1[23:0]) + ((SRC0[7:0] × SRC1[31:24]) << 24)) + ((SRC0[31:24] × SRC1[7:0]) << 24)). MI_1 of the multiplexor 614 may select the output of the adder 630, which may be directed to the left input of the adder 616. MI_2 of the multiplexor 618 may select the left input 0x0 of the multiplexor 618, which may be directed to the right input of the adder 616. The adder 616 may add the output of the multiplexor 614 (i.e., the result of the 32x32 MUL) to the output of the multiplexor 618 (i.e., 0x0), which may result in an output which is the 32x32 MUL of SRC0[31:0] and SRC1[31:0].

In another example, MI_1 may be set to select the output of the adder 630. MI_2 may be set to select the right input SRC2 of the multiplexor 418. MI_3 may be set to select the right input to the multiplexor 620 (i.e., SRC0[7:0]), the right input to the multiplexor 622 (i.e., 0x0), the right input to the multiplexor 624 (i.e., 0x0), and the right input to the multiplexor 626 (i.e., SRC0[31:24]). MI_4 may be unset to select the output of the multiplier 602. This setting may perform a 32x32 MUL_ACC. The multiplier 602 may calculate the product of SRC0[23:0] and SRC1[23:0], which may be directed to the left input of the multiplexor 614 and to the left input of the multiplexor 628. MI_3 of the multiplexor 620 may select the right input, which is SRC0[7:0]. The multiplier 604 may calculate the product of SRC0[7:0] and SRC1[31:24], which may be directed to the shifter 632. MI_4 of the shifter 632 may select to left shift the output of the multiplier 604 by 24 bits, such that the 8 LSBs (i.e., [7:0]) of the output of the multiplier 604 are directed to the 8 MSBs (i.e., [31:24]) of the first input of the adder 630. The shifter 632 may pad the 24 LSBs (i.e., [23:0]) of the 32-bit first input of the adder 630 with zeroes. MI_3 of the multiplexor 622 may select the right input, which is 0x0. The multiplier 606 may calculate the product of 0x0 and SRC1[23:16], which may be 0x0, and may be directed to the right input of the multiplexor 628. MI_4 of the multiplexor 628 may select the output of the multiplier 602, which may be directed to the 32-bit second input of the adder 630. MI_3 of the multiplexor 624 may select the right input, which is 0x0. The multiplier 608 may calculate the product of 0x0 and SRC1[15:8], which may be 0x0, which may be directed to the 32-bit third input of the adder 630. MI_3 of the multiplexor 626 may select the right input, which is SRC0[31:24]. The multiplier 610 may calculate the product of SRC0[31:24] and SRC1[7:0], which may be directed to the shifter 634. MI_4 of the shifter 634 may select to left shift the output of the multiplier 610 by 24 bits, such that the 8 LSBs (i.e., [7:0]) of the output of the multiplier 610 are directed to the 8 MSBs (i.e., [31:24]) of the fourth input of the adder 630. The shifter 634 may pad the 24 LSBs (i.e., [23:0]) of the 32-bit fourth input of the adder 630 with zeroes. The adder 630 may add each of the four inputs to calculate a sum that is fed to the right input of the multiplexor 614. Since the output of the multiplier 608 is 0x0, the sum of the adder 630 may be the left-shifted output of the multiplier 604 (i.e., ((SRC0[7:0] × SRC1[31:24]) << 24)), the left-shifted output of the multiplier 610 (i.e., ((SRC0[31:24] × SRC1[7:0]) << 24)), and the output of the multiplexor 628 (e.g., the product of SRC0[23:0] and SRC1[23:0]). The complete formula of the adder 516 may also be represented by (SRC0[23:0] × SRC1[23:0]) + ((SRC0[7:0] × SRC1[31:24]) << 24)) + ((SRC0[31:24] × SRC1[7:0]) << 24)). MI_1 of the multiplexor 614 may select the output of the adder 630, which may be directed to the left input of the adder 616. MI_2 of the multiplexor 618 may select the right input, which is the 32-bit input SRC2, or SRC2[31:0]. The output of the multiplexor 618 (i.e., SRC2[31:0]) may be directed to the right input of the adder 616. The adder 616 may add the output of the multiplexor 614 (i.e., the result of the 32x32 MUL) to the output of the multiplexor 618 (i.e., SRC2[31:0]), which may result in an output which is the 32x32 MUL_ACC of SRC0[31:0], SRC1[31:0], SRC2[31:0].

In another example, MI_1 may be set to select the output of the adder 630. MI_2 may be unset to select the left input 0x0 of the multiplexor 618. MI_3 may be unset to select the left input to the multiplexor 620 (i.e., SRC0[31:24]), the left input to the multiplexor 622 (i.e., SRC0[23:16]), the left input to the multiplexor 624 (i.e., SRC0[15:8]), and the left input to the multiplexor 626 (i.e., SRC0[7:0]). MI_4 may be set to select the output of the multiplier 606. This setting may perform an 8-bit DP4. MI_3 of the multiplexor 620 may select the left input, which is SRC0[31:24]. The multiplier 604 may calculate the product of SRC0[31:24] and SRC1[31:24], which may be directed to the shifter 632. MI_4 of the shifter 632 may select to refrain from left-shifting the output of the multiplier 604, directing the output of the multiplier 604 to the 32-bit first input of the adder 630. MI_3 of the multiplexor 622 may select the left input, which is SRC0[23:16]. The multiplier 606 may calculate the product of SRC0[23:16] and SRC1[23:16], which may be directed to the 32-bit right input of the multiplexor 628. MI_4 of the multiplexor 628 may select the output of the multiplier 606, which may be directed to the 32-bit second input of the adder 630. MI_3 of the multiplexor 624 may select the left input, which is SRC0[15:8]. The multiplier 608 may calculate the product of SRC0[15:8] and SRC1[15:8], which may be directed to the 32-bit third input of the adder 630. MI_3 of the multiplexor 626 may select the left input, which is SRC0[7:0]. The multiplier 610 may calculate the product of SRC0[7:0] and SRC1[7:0], which may be directed to the shifter 634. MI_4 of the shifter 634 may select to refrain from left-shifting the output of the multiplier 610, directing the output of the multiplier 610 to the 32-bit fourth input of the adder 630. The adder 630 may add each of the four products to calculate a sum that is fed to the right input of the multiplexor 614. MI_1 of the multiplexor 614 may select the right input, which is the output of the adder 630. MI_2 of the multiplexor 618 may select the left input 0x0 of the multiplexor 618, which may be directed to the right input of the adder 616. The adder 616 may add the output of the multiplexor 614 (i.e., the result of the 8-bit DP4) to the output of the multiplexor 618 (i.e., 0x0), which may result in an output which is the 8-bit DP4 of SRC0[31:24], SRC1[31:24], SRC0[23:16], SRC1[23:16], SRC0[15:8], SRC1[15:8], SRC0[7:0], and SRC1[7:0].

In another example, MI_1 may be set to select the output of the adder 630. MI_2 may be set to select the right input SRC2 of the multiplexor 618. MI_3 may be unset to select the left input to the multiplexor 620 (i.e., SRC0[31:24]), the left input to the multiplexor 622 (i.e., SRC0[23:16]), the left input to the multiplexor 624 (i.e., SRC0[15:8]), and the left input to the multiplexor 626 (i.e., SRC0[7:0]). MI_4 may be set to select the output of the multiplier 606. This setting may perform an 8-bit DP4_ACC. MI_3 of the multiplexor 620 may select the left input, which is SRC0[31:24]. The multiplier 604 may calculate the product of SRC0[31:24] and SRC1[31:24], which may be directed to the shifter 632. MI_4 of the shifter 632 may select to refrain from left-shifting the output of the multiplier 604, directing the output of the multiplier 604 to the 32-bit first input of the adder 630. MI_3 of the multiplexor 622 may select the left input, which is SRC0[23:16]. The multiplier 606 may calculate the product of SRC0[23:16] and SRC1[23:16], which may be directed to the 32-bit right input of the multiplexor 628. MI_4 of the multiplexor 628 may select the output of the multiplier 606, which may be directed to the 32-bit second input of the adder 630. MI_3 of the multiplexor 624 may select the left input, which is SRC0[15:8]. The multiplier 608 may calculate the product of SRC0[15:8] and SRC1[15:8], which may be directed to the 32-bit third input of the adder 630. MI_3 of the multiplexor 626 may select the left input, which is SRC0[7:0]. The multiplier 610 may calculate the product of SRC0[7:0] and SRC1[7:0], which may be directed to the shifter 634. MI_4 of the shifter 634 may select to refrain from left-shifting the output of the multiplier 610, directing the output of the multiplier 610 to the 32-bit fourth input of the adder 630. The adder 630 may add each of the four products to calculate a sum that is fed to the right input of the multiplexor 614. MI_1 of the multiplexor 614 may select the right input, which is the output of the adder 630. MI_2 of the multiplexor 618 may select the right input, which is the 32-bit input SRC2, or SRC2[31:0]. The adder 616 may add the output of the multiplexor 614 (i.e., the result of the 8-bit DP4) to the output of the multiplexor 618 (i.e., SRC2[31:0]), which may result in an output which is the 8-bit DP4_ACC of SRC0[31:24], SRC1[31:24], SRC0[23:16], SRC1[23:16], SRC0[15:8], SRC1[15:8], SRC0[7:0], SRC1[7:0] and SRC2[31:0]).

The set of hardware devices in FIG. 6 may efficiently perform a 24x24 MUL, a 24x24 MUL_ACC, a 32x32 MUL, a 32x32 MUL_ACC, an 8-bit DP4, and an 8-bit DP4_ACC. The size of the set of hardware devices in FIG. 6 may be larger than the size of the set of hardware devices in FIG. 5, as a 32-bit adder tends to be considerably larger than a 16-bit adder. However, this size may be mitigated by configuring an adder to have one 32-bit input (for the output of the multiplexor 628) and three 16-bit inputs. The set of hardware devices in FIG. 6 may be used to efficiently provide a hardware calculator that can efficiently perform a plurality of operations.

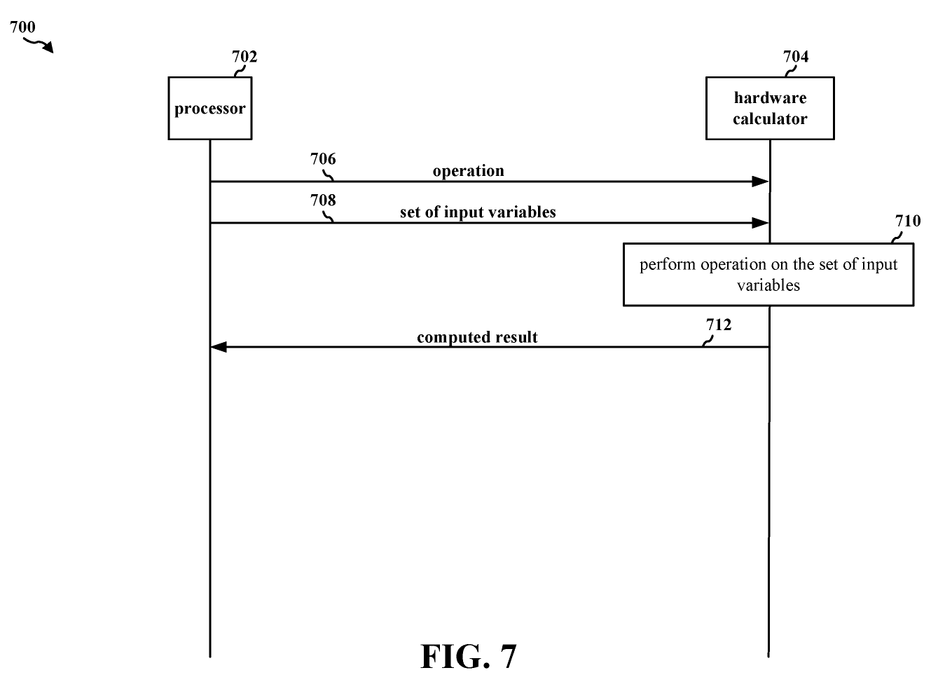

FIG. 7 is a call flow diagram 700 illustrating example communications between a processor 702 and a hardware calculator, in accordance with one or more techniques of this disclosure. The processor may be configured to execute a set of instructions, where the instructions specify the input data for an operation to be performed by the hardware calculator 704. The instructions may specify the input data as an indicator of what GPRs may include the input data. For example, where the instructions are to multiply two 32-bit numbers, the instructions may provide an indicator of what GPRs store the values of the two 32-bit numbers. In another example, where the instructions are to perform an 8-bit DP4 of eight 8-bit numbers, the instructions may provide an indicator of what GPRs store the values of the eight 8-bit numbers. The instructions may also specify indicators of registers used to control the multiplexors within the hardware calculator 704. The processor 702 may include an instruction decoder that translates the instructions to address indicators that indicate the GPR storage used to select the inputs.

The processor 702 may be configured to output an indication 706 of an operation to the hardware calculator 704. The hardware calculator 704 may obtain the indication 706 of the operation from the processor 702. In some aspects, the indication 706 may indicate for the hardware calculator 704 to perform a 24x24 MUL, a 24x24 MUL_ACC, a 32x32 MUL, a 32x32 MUL_ACC, an 8-bit DP4, or an 8-bit DP4_ACC. The hardware calculator 704 may direct the indication 706 of the operation to a set of multiplexors of the hardware calculator 704, for example MI_1 and MI_2 in FIGS. 2 or 3, and/or MI_1, MI_2, MI_3, and MI_4 in FIGS. 4 or 5. The processor 702 may output an indication 708 of a set of input variables (e.g., a set of integer numbers or FP numbers) to the hardware calculator 704. The hardware calculator 704 may obtain the indication 708 of the set of input variables from the processor 702. The hardware calculator 704 may direct the set of input variables to various hardware devices, for example multiplexors, multipliers, and/or adders. At 710, the hardware calculator 704 may perform the indicated operation on the indicated set of input variables via a set of hardware devices. The hardware calculator 704 may output an indication 712 of the computed result to the processor 702. The processor 702 may obtain the indication 712 of the computed result from the hardware calculator 704. The processor 702 may store the indication 712 of the computed result to a memory, or my output the indication 712 of the computed result to a component of a processor, for example a graphics pipeline stage.

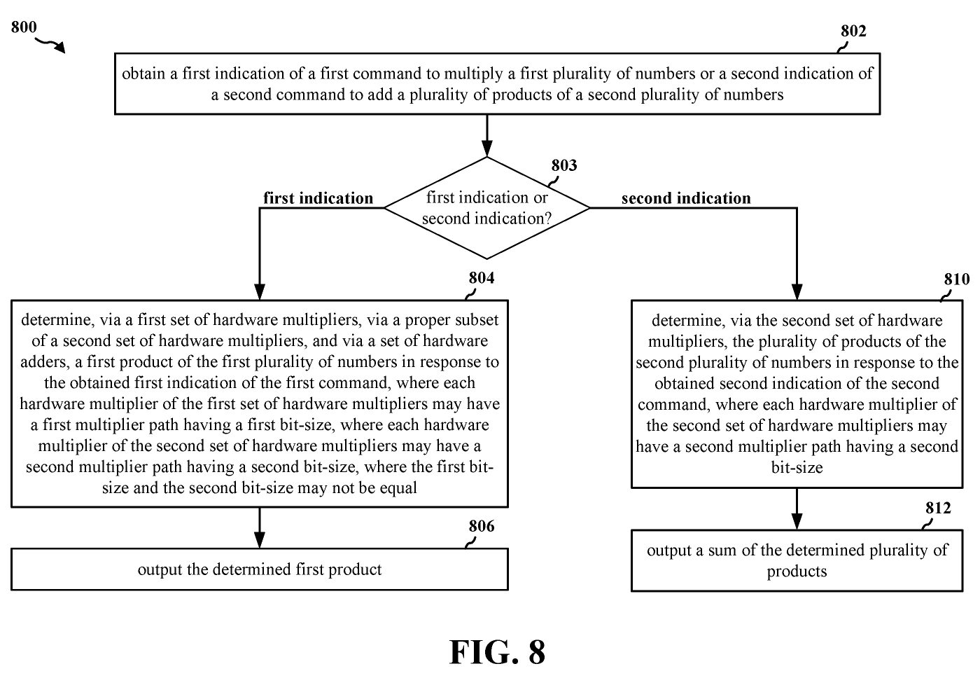

FIG. 8 is a flowchart 800 of an example method of graphics processing in accordance with one or more techniques of this disclosure. The method may be performed by an apparatus, such as an apparatus for graphics processing, a GPU, a CPU, a wireless communication device, and the like, as used in connection with the aspects of FIGS. 1-7.

At 802, the apparatus may obtain a first indication of a first command to multiply a first plurality of numbers or a second indication of a second command to add a plurality of products of a second plurality of numbers. For example, 802 may be performed by the hardware calculator 704 in FIG. 7, which may obtain an indication 706 of an operation from the processor 702. The indication 706 may be a first indication of a first command to multiply a first plurality of numbers (e.g., a 32x32 MUL/MUL ACC) or a second indication of a second command to add a plurality of products of a second plurality of numbers (e.g., a DP4). Moreover, 802 may be performed by the hardware calculator 198 in FIG. 1.

At 803, the apparatus may determine whether the indication is the first indication or the second indication. For example, 803 may be performed by the hardware calculator 704 in FIG. 7, which may determine whether the indication is the first indication or the second indication by routing the indication to the appropriate multiplexor inputs. The multiplexors may determine which inputs to route to their outputs. Moreover, 803 may be performed by the hardware calculator 198 in FIG. 1.

At 804, the apparatus may determine, via a first set of hardware multipliers, via a proper subset of a second set of hardware multipliers, and via a set of hardware adders, a first product of the first plurality of numbers in response to the obtained first indication of the first command. Each hardware multiplier of the first set of hardware multipliers may have a first multiplier path having a first bit-size. Each hardware multiplier of the second set of hardware multipliers may have a second multiplier path having a second bit-size. The first bit-size and the second bit-size may not be equal. For example, 804 may be performed by the hardware calculator 704 in FIG. 7, which may, at 710, perform the operation indicated by the indication 706 on the set of input variables indicated by the indication 708 received from the processor 702. The operation may be, for example, a 32x32 MUL or a MUL ACC operation. The hardware calculator 704 may determine, via a first set of hardware multipliers (e.g., a 24x24 MUL), via a proper subset of a second set of hardware multipliers (e.g., two 8x8 MULs of a set of four 8x8 MULs), and via a set of hardware adders (e.g., an adder configured to add four input numbers), a first product of the first plurality of numbers in response to the obtained first indication of the first command. Each hardware multiplier of the first set of hardware multipliers may have a first multiplier path having a first bit-size (e.g., 24-bits). Each hardware multiplier of the second set of hardware multipliers may have a second multiplier path having a second bit-size (e.g., 8-bits). The first bit-size and the second bit-size may not be equal. Moreover, 804 may be performed by the hardware calculator 198 in FIG. 1.

At 806, the apparatus may output the determined first product. For example, 806 may be performed by the hardware calculator 704 in FIG. 7, which may output the determined first product. The hardware calculator 704 may output the determined first product by storing the determined first product on a memory, for example a set of general purpose registers, or by outputting the determined first product to a component of a GPU pipeline. Moreover, 806 may be performed by the hardware calculator 198 in FIG. 1.

At 810, the apparatus may determine, via the second set of hardware multipliers, the plurality of products of the second plurality of numbers in response to the obtained second indication of the second command. Each hardware multiplier of the second set of hardware multipliers may have a second multiplier path having a second bit-size. For example, 810 may be performed by the hardware calculator 704 in FIG. 7, which may determine, via the second set of hardware multipliers (e.g., a set of four 8x8 MUL), the plurality of products of the second plurality of numbers in response to the obtained second indication of the second command. Each hardware multiplier of the second set of hardware multipliers may have a second multiplier path having a second bit-size (e.g., an 8-bit size). Moreover, 810 may be performed by the hardware calculator 198 in FIG. 1.

At 812, the apparatus may output a sum of the determined plurality of products. For example, 812 may be performed by the hardware calculator 704 in FIG. 7, which may output a sum of the determined plurality of products. The hardware calculator 704 may output the sum of the determined plurality of products by storing the determined first product on a memory, for example a set of general purpose registers, or by outputting the sum of the determined plurality of products to a component of a GPU pipeline. Moreover, 812 may be performed by the hardware calculator 198 in FIG. 1.

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware within the device 104 or another device. The apparatus may include means for obtaining a first indication of a first command to multiply a first plurality of numbers or a second indication of a second command to add a plurality of products of a second plurality of numbers. The apparatus may further include means for determining, via a first set of hardware multipliers, via a proper subset of a second set of hardware multipliers, and via a set of hardware adders, a first product of the first plurality of numbers in response to the obtained first indication of the first command. The apparatus may further include means for determining, via the second set of hardware multipliers, the plurality of products of the second plurality of numbers in response to the obtained second indication of the second command. Each hardware multiplier of the first set of hardware multipliers may have a first multiplier path having a first bit-size. Each hardware multiplier of the second set of hardware multipliers may have a second multiplier path having a second bit-size. The first bit-size and the second bit-size may not be equal. The apparatus may further include means for outputting the determined first product or a sum of the determined plurality of products. The first bit-size may be greater than the second bit-size. The first bit-size may be 24-bits. The second bit-size may be 8-bits. The first set of hardware multipliers may include a single 24-bit by 24-bit hardware multiplier. The second set of hardware multipliers may include four 8-bit by 8-bit hardware multipliers. The first command may include a command to multiply two 32-bit numbers. The second command may include a command to perform a four wide vector dot product (DP4) of eight 8-bit numbers. The apparatus may further include means for obtaining a third indication of a third command to multiply a third plurality of numbers. The apparatus may further include means for determining, via the first set of hardware multipliers and not the second set of hardware multipliers, a third product of the third plurality of numbers in response to the obtained third indication of the third command. The apparatus may further include means for outputting the determined third product. The first plurality of numbers may be 32-bit numbers. The third plurality of numbers may be 24-bit numbers. The first plurality of numbers may be a first number and a second number. The first number may have a first portion, a second portion, and a third portion. The second number may have a fourth portion, a fifth portion, and a sixth portion. The apparatus may further include means for determining, via the first set of hardware multipliers and the proper subset of the second set of hardware multipliers, the first product of the first plurality of numbers in response to the obtained first indication of the first command by (a) determining, via the first set of hardware multipliers, a third product of the first portion and the fourth portion, (b) determining, via a first hardware multiplier of the second set of hardware multipliers, a fourth product of the second portion and the sixth portion, (c) determining, via a second hardware multiplier of the second set of hardware multipliers, a fifth product of the third portion and the fifth portion, and (d) determining, via the set of hardware adders, a sum of the determined third product, the determined fourth product, and the determined fifth product. The apparatus may further include means for determining, via the set of hardware adders, the sum of the determined third product, the determined fourth product, and the determined fifth product by (a) selecting, via a first hardware multiplexor, a first output of the first set of hardware multipliers, (b) determining, via a first hardware adder of the set of hardware adders, a first sum of the determined fourth product and the determined fifth product, and (c) determining, via a second hardware adder of the set of hardware adders, a second sum of the first sum and the selected first output of the first set of hardware multipliers. The determined first product may be the determined second sum. The first hardware adder may be a 16-bit hardware adder. The second hardware adder may be a 32-bit hardware adder. The apparatus may further include means for determining, via the set of hardware adders, the sum of the determined third product, the determined fourth product, and the determined fifth product by determining, via a hardware adder of the set of hardware adders, a sum of the determined third product, the determined fourth product, and the determined fifth product. The determined first product may be the determined sum. The hardware adder may be a 32-bit hardware adder. The apparatus may further include means for obtaining a third indication of a third command to add a fourth number to a product of a fifth number and a sixth number. The fifth number may include a seventh portion, an eighth portion, and a ninth portion. The sixth number may include a tenth portion, an eleventh portion, and a twelfth portion. The apparatus may further include means for determining, via the first set of hardware multipliers, a sixth product of the seventh portion and the tenth portion. The apparatus may further include means for determining, via the first hardware multiplier of the second set of hardware multipliers, a seventh product of the eighth portion and the twelfth portion. The apparatus may further include means for determining, via the second hardware multiplier of the second set of hardware multipliers, an eighth product of the ninth portion and the eleventh portion. The apparatus may further include means for determining, via the hardware adder of the set of hardware adders, a first sum of the determined sixth product, the determined seventh product, and the determined eighth product. The apparatus may further include means for determining, via a second hardware adder of the set of hardware adders, a second sum of the determined first sum and the fourth number; and outputting the determined second sum. The second plurality of numbers may include a first number, a second number, a third number, a fourth number, a fifth number, a sixth number, a seventh number, and an eighth number. The apparatus may further include means for determining, via the second set of hardware multipliers, the plurality of products of the second plurality of numbers in response to the obtained second indication of the second command by (a) determining, via a first hardware multiplier of the second set of hardware multipliers, a third product of the first number and the fifth number, (b) determining, via a second hardware multiplier of the second set of hardware multipliers, a fourth product of the second number and the sixth number, (c) determining, via a third hardware multiplier of the second set of hardware multipliers, a fifth product of the third number and the seventh number, (d) determining, via a fourth hardware multiplier of the second set of hardware multipliers, a sixth product of the fourth number and the eighth number, and (e) determining, via a hardware adder, a sum of the determined third product, the determined fourth product, the determined fifth product, and the determined sixth product. Each of the first hardware multiplier, the second hardware multiplier, the third hardware multiplier, and the fourth hardware multiplier may include an 8-bit by 8-bit hardware multiplier. The apparatus may further include means for outputting the determined first product or the sum of the determined plurality of products by outputting an indication of the determined first product or the sum of the determined plurality of products. The apparatus may further include means for outputting the determined first product or the sum of the determined plurality of products by storing an indication of the determined first product or the sum of the determined plurality of products. The apparatus may further include means for determining, via the set of hardware adders, the sum of the determined third product, the determined fourth product, and the determined fifth product by selecting, via a second hardware multiplexor, a second output of the first hardware adder. A third output of the second hardware multiplexor may be connected to an input of the second hardware adder associated with the first sum.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S ⊆ F. Accordingly, each processor of the at least one processor may be configured to perform a particular subset of the set of functions, where the subset is the full set, a proper subset of the set, or an empty subset of the set. A proper subset of a set has one or more elements of the full set, but does not include the full set itself. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

An indication of a set of data may include the data itself, or a reference to the data, for example a memory address where the data may be retrieved by the receiving entity, or an index to a set of data (e.g., an index of 1 that represents the series of bits 1100101). A single indication may also include a set of indications, for example an array of memory addresses or a plurality of index references.

The following aspects are illustrative only and may be combined with other aspects or teachings described herein, without limitation.

Aspect 1 is a method of calculation, comprising: obtaining a first indication of a first command to multiply a first plurality of numbers or a second indication of a second command to add a plurality of products of a second plurality of numbers; determining, via a first set of hardware multipliers, via a proper subset of a second set of hardware multipliers, and via a set of hardware adders, a first product of the first plurality of numbers in response to the obtained first indication of the first command; or determining, via the second set of hardware multipliers, the plurality of products of the second plurality of numbers in response to the obtained second indication of the second command, wherein each hardware multiplier of the first set of hardware multipliers has a first multiplier path having a first bit-size, wherein each hardware multiplier of the second set of hardware multipliers has a second multiplier path having a second bit-size, wherein the first bit-size and the second bit-size are not equal; and outputting the determined first product or a sum of the determined plurality of products.

Aspect 2 is the method of aspect 1, wherein the first bit-size is greater than the second bit-size.

Aspect 3 is the method of any of aspects 1 to 2, wherein the first bit-size comprises 24-bits and the second bit-size comprises 8-bits.

Aspect 4 is the method of any of aspects 1 to 3, wherein the first set of hardware multipliers comprises a single 24-bit by 24-bit hardware multiplier, wherein the second set of hardware multipliers comprises four 8-bit by 8-bit hardware multipliers, wherein the first command comprises a command to multiply two 32-bit numbers, and wherein the second command comprises a command to perform a four wide vector dot product (DP4) of eight 8-bit numbers.

Aspect 5 is the method of any of aspects 1 to 4, further comprising: obtaining a third indication of a third command to multiply a third plurality of numbers; determining, via the first set of hardware multipliers and not the second set of hardware multipliers, a third product of the third plurality of numbers in response to the obtained third indication of the third command; and outputting the determined third product.

Aspect 6 is the method of aspect 5, wherein the first plurality of numbers comprises 32-bit numbers, wherein the third plurality of numbers comprise 24-bit numbers.

Aspect 7 is the method of any of aspects 1 to 6, wherein the first plurality of numbers comprises a first number and a second number, wherein the first number comprises a first portion, a second portion, and a third portion, and the second number comprises a fourth portion, a fifth portion, and a sixth portion, wherein determining, via the first set of hardware multipliers and the proper subset of the second set of hardware multipliers, the first product of the first plurality of numbers in response to the obtained first indication of the first command comprises: determining, via the first set of hardware multipliers, a third product of the first portion and the fourth portion; determining, via a first hardware multiplier of the second set of hardware multipliers, a fourth product of the second portion and the sixth portion; determining, via a second hardware multiplier of the second set of hardware multipliers, a fifth product of the third portion and the fifth portion; and determining, via the set of hardware adders, a sum of the determined third product, the determined fourth product, and the determined fifth product.

Aspect 8 is the method of aspect 7, wherein determining, via the set of hardware adders, the sum of the determined third product, the determined fourth product, and the determined fifth product, comprises: selecting, via a first hardware multiplexor, a first output of the first set of hardware multipliers; determining, via a first hardware adder of the set of hardware adders, a first sum of the determined fourth product and the determined fifth product; and determining, via a second hardware adder of the set of hardware adders, a second sum of the first sum and the selected first output of the first set of hardware multipliers, wherein the determined first product comprises the determined second sum.

Aspect 9 is the method of aspect 8, wherein the first hardware adder comprises a 16-bit hardware adder, and wherein the second hardware adder comprises a 32-bit hardware adder.

Aspect 10 is the method of any of aspects 7 to 9, wherein determining, via the set of hardware adders, the sum of the determined third product, the determined fourth product, and the determined fifth product, comprises: determining, via a hardware adder of the set of hardware adders, a sum of the determined third product, the determined fourth product, and the determined fifth product, wherein the determined first product comprises the determined sum.

Aspect 11 is the method of aspect 10, wherein the hardware adder comprises a 32-bit hardware adder.

Aspect 12 is the method of either of aspects 10 or 11, further comprising: obtaining a third indication of a third command to add a fourth number to a product of a fifth number and a sixth number, wherein the fifth number comprises a seventh portion, an eighth portion, and a ninth portion, wherein the sixth number comprises a tenth portion, an eleventh portion, and a twelfth portion; determining, via the first set of hardware multipliers, a sixth product of the seventh portion and the tenth portion; determining, via the first hardware multiplier of the second set of hardware multipliers, a seventh product of the eighth portion and the twelfth portion; determining, via the second hardware multiplier of the second set of hardware multipliers, an eighth product of the ninth portion and the eleventh portion; determining, via the hardware adder of the set of hardware adders, a first sum of the determined sixth product, the determined seventh product, and the determined eighth product; determining, via a second hardware adder of the set of hardware adders, a second sum of the determined first sum and the fourth number; and outputting the determined second sum.

Aspect 13 is the method of any of aspects 1 to 12, wherein the second plurality of numbers comprises a first number, a second number, a third number, a fourth number, a fifth number, a sixth number, a seventh number, and an eighth number, wherein determining, via the second set of hardware multipliers, the plurality of products of the second plurality of numbers in response to the obtained second indication of the second command comprises: determining, via a first hardware multiplier of the second set of hardware multipliers, a third product of the first number and the fifth number; determining, via a second hardware multiplier of the second set of hardware multipliers, a fourth product of the second number and the sixth number; determining, via a third hardware multiplier of the second set of hardware multipliers, a fifth product of the third number and the seventh number; determining, via a fourth hardware multiplier of the second set of hardware multipliers, a sixth product of the fourth number and the eighth number; and determining, via a hardware adder, a sum of the determined third product, the determined fourth product, the determined fifth product, and the determined sixth product.

Aspect 14 is the method of aspect 13, wherein each of the first hardware multiplier, the second hardware multiplier, the third hardware multiplier, and the fourth hardware multiplier comprises an 8-bit by 8-bit hardware multiplier.

Aspect 15 is the method of any of aspects 1 to 14, wherein outputting the determined first product or the sum of the determined plurality of products comprises: outputting an indication of the determined first product or the sum of the determined plurality of products; or storing an indication of the determined first product or the sum of the determined plurality of products.

Aspect 16 is the method of aspect 8, wherein determining, via the set of hardware adders, the sum of the determined third product, the determined fourth product, and the determined fifth product comprises: selecting, via a second hardware multiplexor, a second output of the first hardware adder, wherein a third output of the second hardware multiplexor is connected to an input of the second hardware adder associated with the first sum.

Aspect 17 is an apparatus for processing a calculation including at least one processor coupled to a memory and configured to implement a method as in any of aspects 1 to 16.

Aspect 18 may be combined with aspect 17 and includes that the apparatus is a wireless communication device.

Aspect 19 is an apparatus for processing a calculation including means for implementing a method as in any of aspects 1 to 16.

Aspect 20 is a computer-readable medium (e.g., a non-transitory computer-readable medium) storing computer executable code, the code when executed by at least one processor causes the at least one processor to implement a method as in any of aspects 1 to 16.

Various aspects have been described herein. These and other aspects are within the scope of the following claims.

What is claimed is:

1. An apparatus for calculation, comprising:
a memory; and
a processor coupled to the memory and, based at least in part on information stored in the memory, the processor is configured to:
obtain a first indication of a first command to multiply a first plurality of numbers or a second indication of a second command to add a plurality of products of a second plurality of numbers;
determine, via a first set of hardware multipliers, via a proper subset of a second set of hardware multipliers, and via a set of hardware adders, a first product of the first plurality of numbers in response to the obtained first indication of the first command; or
determine, via the second set of hardware multipliers, the plurality of products of the second plurality of numbers in response to the obtained second indication of the second command, wherein each hardware multiplier of the first set of hardware multipliers has a first multiplier path having a first bit-size, wherein each hardware multiplier of the second set of hardware multipliers has a second multiplier path having a second bit-size, wherein the first bit-size and the second bit-size are not equal; and
output the determined first product or a sum of the determined plurality of products.

2. The apparatus of claim 1, wherein the first bit-size is greater than the second bit-size.

3. The apparatus of claim 1, wherein the first bit-size comprises 24-bits and the second bit-size comprises 8-bits.

4. The apparatus of claim 1, wherein the first set of hardware multipliers comprises a single 24-bit by 24-bit hardware multiplier, wherein the second set of hardware multipliers comprises four 8-bit by 8-bit hardware multipliers, wherein the first command comprises a command to multiply two 32-bit numbers, and wherein the second command comprises a command to perform a four wide vector dot product (DP4) of eight 8-bit numbers.

5. The apparatus of claim 1, wherein the processor is further configured to:
obtain a third indication of a third command to multiply a third plurality of numbers;
determine, via the first set of hardware multipliers and not the second set of hardware multipliers, a third product of the third plurality of numbers in response to the obtained third indication of the third command; and
output the determined third product.

6. The apparatus of claim 5, wherein the first plurality of numbers comprises 32-bit numbers, wherein the third plurality of numbers comprise 24-bit numbers.

7. The apparatus of claim 1, wherein the first plurality of numbers comprises a first number and a second number, wherein the first number comprises a first portion, a second portion, and a third portion, and the second number comprises a fourth portion, a fifth portion, and a sixth portion, wherein, to determine, via the first set of hardware multipliers and the proper subset of the second set of hardware multipliers, the first product of the first plurality of numbers in response to the obtained first indication of the first command, the processor is configured to:
determine, via the first set of hardware multipliers, a third product of the first portion and the fourth portion;
determine, via a first hardware multiplier of the second set of hardware multipliers, a fourth product of the second portion and the sixth portion;
determine, via a second hardware multiplier of the second set of hardware multipliers, a fifth product of the third portion and the fifth portion; and
determine, via the set of hardware adders, a second sum of the determined third product, the determined fourth product, and the determined fifth product, wherein the determined first product comprises the determined second sum.

8. The apparatus of claim 7, wherein, to determine, via the set of hardware adders, the second sum of the determined third product, the determined fourth product, and the determined fifth product, the processor is configured to:
determine, via a first hardware adder of the set of hardware adders, a third sum of the determined fourth product and the determined fifth product;
select, via a first hardware multiplexor, a first output of the first set of hardware multipliers; and
determine, via a second hardware adder of the set of hardware adders, a fourth sum of the third sum and the selected first output of the first set of hardware multipliers, wherein the determined first product comprises the determined fourth sum.

9. The apparatus of claim 8, wherein the first hardware adder comprises a 16-bit hardware adder, and wherein the second hardware adder comprises a 32-bit hardware adder.

10. The apparatus of claim 8, wherein, to determine, via the set of hardware adders, the second sum of the determined third product, the determined fourth product, and the determined fifth product, the processor is configured to:
select, via a second hardware multiplexor, a second output of the first hardware adder, wherein a third output of the second hardware multiplexor is connected to an input of the second hardware adder associated with the second sum.

11. The apparatus of claim 7, wherein, to determine, via the set of hardware adders, the second sum of the determined third product, the determined fourth product, and the determined fifth product, the processor is configured to:
determine, via a hardware adder of the set of hardware adders, the second sum of the determined third product, the determined fourth product, and the determined fifth product, wherein the determined first product comprises the determined second sum.

12. The apparatus of claim 11, wherein the hardware adder comprises a 32-bit hardware adder.

13. The apparatus of claim 11, wherein the processor is further configured to:
obtain a third indication of a third command to add a fourth number to a product of a fifth number and a sixth number, wherein the fifth number comprises a seventh portion, an eighth portion, and a ninth portion, wherein the sixth number comprises a tenth portion, an eleventh portion, and a twelfth portion;
determine, via the first set of hardware multipliers, a sixth product of the seventh portion and the tenth portion;
determine, via the first hardware multiplier of the second set of hardware multipliers, a seventh product of the eighth portion and the twelfth portion;
determine, via the second hardware multiplier of the second set of hardware multipliers, an eighth product of the ninth portion and the eleventh portion;
determine, via the hardware adder of the set of hardware adders, a third sum of the determined sixth product, the determined seventh product, and the determined eighth product;
determine, via a second hardware adder of the set of hardware adders, a fourth sum of the determined third sum and the fourth number; and
output the determined fourth sum.

14. The apparatus of claim 1, wherein the second plurality of numbers comprises a first number, a second number, a third number, a fourth number, a fifth number, a sixth number, a seventh number, and an eighth number, wherein, to determine, via the second set of hardware multipliers, the plurality of products of the second plurality of numbers in response to the obtained second indication of the second command, the processor is configured to:
determine, via a first hardware multiplier of the second set of hardware multipliers, a third product of the first number and the fifth number;
determine, via a second hardware multiplier of the second set of hardware multipliers, a fourth product of the second number and the sixth number;
determine, via a third hardware multiplier of the second set of hardware multipliers, a fifth product of the third number and the seventh number;
determine, via a fourth hardware multiplier of the second set of hardware multipliers, a sixth product of the fourth number and the eighth number; and
determine, via a hardware adder, a second sum of the determined third product, the determined fourth product, the determined fifth product, and the determined sixth product, wherein the determined second sum comprises the sum of the determined plurality of products.

15. The apparatus of claim 14, wherein each of the first hardware multiplier, the second hardware multiplier, the third hardware multiplier, and the fourth hardware multiplier comprises an 8-bit by 8-bit hardware multiplier.

16. The apparatus of claim 1, wherein, to output the determined first product or the sum of the determined plurality of products, the processor is configured to:
output an indication of the determined first product or the sum of the determined plurality of products; or
store an indication of the determined first product or the sum of the determined plurality of products.

17. The apparatus of claim 1, wherein the apparatus comprises a wireless communication device.

18. A method of calculation, comprising:
obtaining a first indication of a first command to multiply a first plurality of numbers or a second indication of a second command to add a plurality of products of a second plurality of numbers;
determining, via a first set of hardware multipliers, via a proper subset of a second set of hardware multipliers, and via a set of hardware adders, a first product of the first plurality of numbers in response to the obtained first indication of the first command; or
determining, via the second set of hardware multipliers, the plurality of products of the second plurality of numbers in response to the obtained second indication of the second command, wherein each hardware multiplier of the first set of hardware multipliers has a first multiplier path having a first bit-size, wherein each hardware multiplier of the second set of hardware multipliers has a second multiplier path having a second bit-size, wherein the first bit-size and the second bit-size are not equal; and
outputting the determined first product or a sum of the determined plurality of products.

19. The method of claim 18, wherein the first plurality of numbers comprises a first number and a second number, wherein the first number comprises a first portion, a second portion, and a third portion, and the second number comprises a fourth portion, a fifth portion, and a sixth portion, wherein determining, via the first set of hardware multipliers and the proper subset of the second set of hardware multipliers, the first product of the first plurality of numbers in response to the obtained first indication of the first command comprises:
determining, via the first set of hardware multipliers, a third product of the first portion and the fourth portion;
determining, via a first hardware multiplier of the second set of hardware multipliers, a fourth product of the second portion and the sixth portion;
determining, via a second hardware multiplier of the second set of hardware multipliers, a fifth product of the third portion and the fifth portion; and
determining, via the set of hardware adders, a second sum of the determined third product, the determined fourth product, and the determined fifth product.

20. A computer-readable medium storing computer executable code, the code when executed by a processor, causes the processor to:
obtain a first indication of a first command to multiply a first plurality of numbers or a second indication of a second command to add a plurality of products of a second plurality of numbers;
determine, via a first set of hardware multipliers, via a proper subset of a second set of hardware multipliers, and via a set of hardware adders, a first product of the first plurality of numbers in response to the obtained first indication of the first command; or
determine, via the second set of hardware multipliers, the plurality of products of the second plurality of numbers in response to the obtained second indication of the second command, wherein each hardware multiplier of the first set of hardware multipliers has a first multiplier path having a first bit-size, wherein each hardware multiplier of the second set of hardware multipliers has a second multiplier path having a second bit-size, wherein the first bit-size and the second bit-size are not equal; and
output the determined first product or a sum of the determined plurality of products.
